(19) United States
(12) Patent Application Publication
(10) Pub. No.: US 2015/0253612 A1
(43) Pub. Date: Sep. 10, 2015

(54) DISPLAY DEVICE

(71) Applicant: PANASONIC INTELLECTUAL PROPERTY MANAGEMENT CO., LTD., Osaka (JP)

(72) Inventors: Kenji Hasegawa, Osaka (JP); Eiichi Uriu, Osaka (JP)

(21) Appl. No.: 14/430,816

(22) PCT Filed: Sep. 27, 2013
(86) PCT No.: PCT/JP2013/005769

§ 371 Date: Mar. 24, 2015

(30) Foreign Application Priority Data
Sep. 28, 2012 (JP) 2012-215893

(51) Int. Cl. G02F 1/1333; G02F 1/1339

(52) U.S. Cl. CPC G02F 1/133308; G02F 1/1339; G02F 2001/133331; G02F 2001/13332; G02F 2001/133311

(57) ABSTRACT

In view of the insufficiency of the prior display device, the objective is to propose a display device capable of more reducing occurrence of dew condensation inside the cabinet caused by a change in environment. To achieve this objective, the display device of the present disclosure includes: a display panel; a glass cover situated opposite a front face of the display panel; and a spacer in a frame shape for fixing the display panel and the glass cover so that the display panel and the glass cover are spaced at a predetermined interval. A space enclosed by the display panel, the glass cover, and the spacer is kept in a dry state.

### TECHNICAL FIELD

The present disclosure relates to display devices for displaying letters, images, and/or the like, and, in particular, to a display device which includes a glass cover situated in front of an image displaying surface in order to be adapted to use in indoor or outdoor severe environments.

### BACKGROUND ART

Patent literature 1 and patent literature 2 relate to a display device in which an image receiver such as a liquid crystal panel is placed inside a sealed cabinet, and disclose a display device capable of both controlling a change in an inner pressure of the cabinet and preventing occurrence of dew condensation inside the cabinet. This display device includes an inner pressure adjuster and a humidity adjuster. The inner pressure adjuster is provided to a rear frame of the cabinet having a sealed structure, and allows air to pass therethrough. The humidity adjuster is situated inside the cabinet, and has a moisture absorption property and is used for prevention of dew condensation. Hence, it is possible to prevent breakage of the cabinet caused by a change in the inner pressure of the cabinet, and also to prevent occurrence of dew condensation caused by intrusion of water vapor into the cabinet.

### CITATION LIST

### Patent Literature

Patent Literature 1: JP 2008-277957 A
Patent Literature 2: JP 2009-181129 A

### SUMMARY OF INVENTION

### Technical Problem

The aforementioned prior display device includes a regulation valve as the inner pressure adjuster, and therefore it is possible to prevent breakage of the cabinet caused by a change in the inner pressure of the display device. However, if an amount of water vapor greater than an amount which can be absorbed by the humidity adjuster intrudes through the regulator valve, dew condensation inside the display device cannot be prevented.

In view of the insufficiency of the prior display device, the objective of the present disclosure is to propose a display device capable of more reducing occurrence of dew concentration inside the cabinet caused by a change in environment.

### Solution to Problem

To achieve this objective, the display device of the present disclosure includes: a display panel; a glass cover situated opposite a front face of the display panel; and a spacer in a frame shape for fixing the display panel and the glass cover so that the display panel and the glass cover are spaced at a predetermined interval. A space enclosed by the display panel, the glass cover, and the spacer is kept in a dry state.

### Advantageous Effects of Invention

In the display device according to the present disclosure, the space between the display panel and the glass cover situated in front of the display panel is kept in the dry state. Therefore, it is possible to reduce occurrence of dew condensation on an inner face of the glass cover caused by a change in environments surrounding the display device.

### BRIEF DESCRIPTION OF DRAWINGS

FIG. 1 is a plan illustrating the whole structure of the display apparatus according to Embodiment 1.

FIG. 2 is an enlarged section illustrating the structure of the display apparatus according to Embodiment 1.

FIG. 3 is a section illustrating the structure of the display apparatus according to Embodiment 1.

FIG. 4 is a diagram illustrating a relationship between a dew-point temperature and a saturated water vapor content of air.

FIG. 5 is a plan illustrating the whole structure of the display apparatus according to Embodiment 2.

FIG. 6 is an enlarged section illustrating the structure of the display apparatus according to Embodiment 2.

FIG. 7 is a plan illustrating the whole structure of the display apparatus according to Embodiment 3.

FIG. 8 is an enlarged section illustrating the structure of the display apparatus according to Embodiment 3.

FIG. 9 is a plan illustrating the whole structure of the display apparatus according to Embodiment 4.

FIG. 10 is an enlarged section illustrating the structure of the display apparatus according to Embodiment 4.

FIG. 11 is a plan illustrating the whole structure of the display apparatus according to Embodiment 5.

FIG. 12 is an enlarged section illustrating the structure of the display apparatus according to Embodiment 5.

FIG. 13 is a perspective view illustrating the configuration of the spacer used in the display apparatus according to Embodiment 5.

FIG. 14 is a plan illustrating the whole structure of the display apparatus according to Embodiment 6.

FIG. 15 is an enlarged section illustrating the structure of the display apparatus according to Embodiment 6.

FIG. 16 is a plan illustrating the whole structure of the table according to Embodiment 7.

FIG. 17 is a section illustrating the structure of the table according to Embodiment 7.

FIG. 18 is an enlarged section illustrating the structure of the table according to Embodiment 7.

FIG. 19 is a perspective view illustrating the whole structure of the wall according to Embodiment 8.

FIG. 20 is a section illustrating the structure of the wall according to Embodiment 8.

FIG. 21 is an enlarged section illustrating the structure of the wall according to Embodiment 8.

FIG. 22 is a plan illustrating the whole structure of the display apparatus including the EL panel as the display panel.

FIG. 23 is an enlarged section illustrating the structure of the display apparatus including the EL panel as the display panel.

FIG. 24 is a view illustrating the appearance of the multiple glass panel including the display device inside.

FIG. 25 is an enlarged section illustrating the structure of the multiple glass panel including the display device inside.

### DESCRIPTION OF EMBODIMENTS

The display device according to the present disclosure includes: a display panel; a glass cover situated opposite a front face of the display panel; and a spacer in a frame shape for fixing the display panel and the glass cover so that the display panel and the glass cover are spaced at a predetermined interval. A space enclosed by the display panel, the glass cover, and the spacer is kept in a dry state.

In the display device according to the present disclosure, the space formed by the glass cover for protecting the surface of the display panel, the display panel, and the spacer in a frame shape is kept in the dry state. Therefore, even if the temperature of the environment surrounding the display device changes sharply, dew condensation is unlikely to occur inside the glass cover. Consequently, it is possible to effectively prevent a disadvantage that an image displayed on the display panel becomes hard to see.

As for the configuration of the display device of the present disclosure, it is preferable that a substance inside the space be replaced with dry air. By replacing air inside the space formed by the display panel, the glass cover, and the spacer by dry air with a low dew-point temperature, the inside of the space can be made to be in a fine dry state.

Further, it is preferable that the display device include a display module which is an integrated component including the display panel, a drive circuit configured to drive at least the display panel, and a chassis configured to hold the display panel and the drive circuit. The chassis include a front end situated to cover part of the front face of the display panel. The spacer is situated between a surface of the front end of the chassis and the glass cover. Due to this, even if the display panel and the drive circuit are provided as a display module by use of the chassis, the space between the display panel and the glass cover can be made to be in the dry state.

This configuration can be modified so that the display panel is a transmissive liquid crystal panel, and the display module further includes a backlight unit for displaying an image on the liquid crystal panel. Due to this, it is possible to easily form a display device including a transmissive liquid crystal panel as a display panel.

Additionally, it is preferable that a display panel sealing member be situated between the front end of the chassis and the display panel and the display panel sealing member define an outer limit of the space. Due to this, it is possible to improve the degree of the airtightness of the space between the glass cover and the display panel.

Moreover, it is preferable that an outside of the spacer be hermetically surrounded by a spacer sealing member. Due to this, it is possible to more improve the degree of the airtightness of the space between the glass cover and the display panel.

Furthermore, it is preferable that the spacer be made of a pipy member. Due to this, it is possible to realize the display device including a spacer member which is both highly stiff and lightweight.

In this case, it is preferable that at least one hole be formed through a face of the spacer facing the space so as to spatially connect an inside of the spacer and the space together and a desiccant is situated in the inside of the spacer. Due to this, it is possible to successfully make the space between the glass cover and the display panel be in the dry state.

Hereinafter, display devices according to the present disclosure are explained in detail with appropriate reference to drawings. In each of following Embodiments, a concrete configuration of a display device including a transmissive liquid crystal panel as a display panel is explained.

Note that, to avoid excessively redundant explanations and to assist the skilled person to understand the present disclosure, in some cases detailed explanation to well-known matters, and explanations to the same components are appropriately summarized or omitted.

Note that, the present inventors provide attached drawings and the following explanations as merely examples in order to help the skilled person to fully understand the present disclosure. Hence, the display devices according to the present disclosure recited in claims should not be interpreted as being limited to only concrete examples shown in the drawings and contents of the explanations.

### Embodiment 1

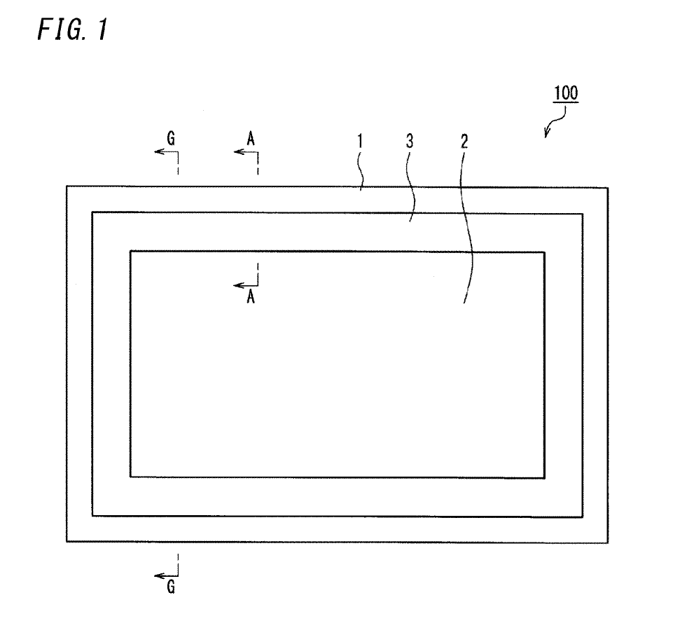

Hereinafter, as Embodiment 1 of the display device according to the present disclosure, an apparatus including a display device is described with reference to FIG. 1 to FIG. 3.

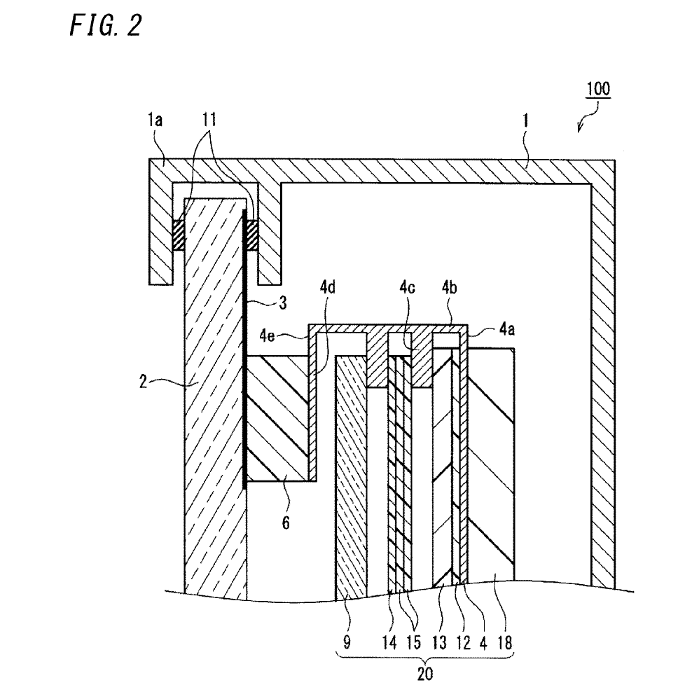

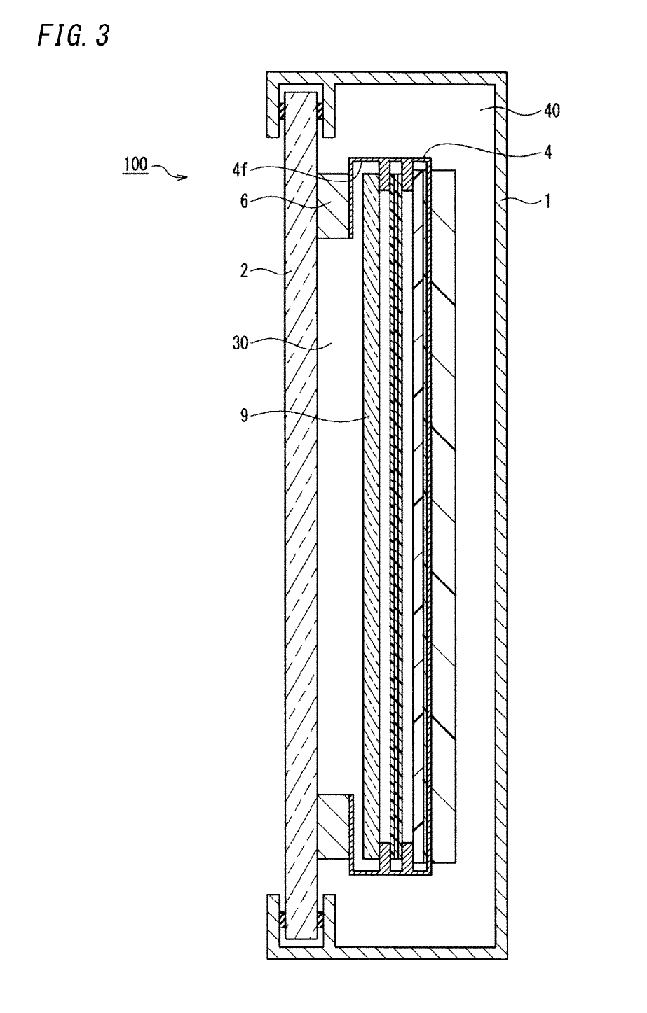

FIG. 1 is a plan illustrating a whole structure of the display apparatus 100 according to Embodiment 1. FIG. 2 is a section illustrating the structure of the display apparatus 100 of Embodiment 1, and in particular is an enlarged section along line A-A in FIG. 1. FIG. 3 is a section illustrating the whole structure of the display apparatus 100 of Embodiment 1, and in particular is a section along line G-G in FIG. 1. With regard to FIG. 2 and FIG. 3, a front side of the display apparatus 100 is directed left in the figures, and a rear side of the display apparatus 100 is directed right in the figures.

As shown in FIG. 1 and FIG. 2, in the display apparatus 100 according to the present embodiment, a glass cover 2, and a display 20 serving as a display module are arranged in this order from the front side of the display apparatus 100, and are accommodated in a cabinet 1.

The display 20 is a display module including a transmissive liquid crystal panel 9 as a display panel. The present embodiment shows an example including an edge light type backlight as a backlight for emitting light for displaying an image on the liquid crystal panel 9.

The display 20 includes at least an LED (light emitting diode: not shown) serving as a light source, a light guide plate 13, a reflection sheet 12, a luminance improvement sheet 15, a diffusion sheet 14, and the liquid crystal panel 9, which are stacked inside a metal chassis 4. The light guide plate 13 receives light emitted from the LED at its side face and then emits light to the liquid crystal panel 9 as a uniform planer light source. The reflection sheet 12 is situated on a rear face of the light guide plate 13 so as to reflect light which travels toward the rear face of the light guide plate 13, toward the liquid crystal panel 9 in front. The luminance improvement sheet 15 allows convergence of rays of light emitted from the light guide plate 13 toward the liquid crystal panel 9 in front, to increase luminance of an image displayed on the liquid crystal panel 9. The diffusion sheet 14 diffuses light emitted from the luminance improvement sheet 15. The liquid crystal panel 9 displays an image by transmitting or blocking light emitted from the diffusion sheet 14 for each of pixels finely partitioned. Note that, in the present embodiment, the liquid crystal panel 9 is illustrated as including a pair of polarization plates on opposite external sides. Further, a circuit board 18 is mounted on a rear face 4a of the chassis 4. On the circuit board 18, electronic parts for constituting a drive circuit are mounted. The drive circuit controls displaying images on the display 20 by generating a voltage for driving the liquid crystal panel 9 and a control signal for displaying an image, and controlling light emission of the LCD serving as the backlight. Note that, in FIG. 2, in order not to complicate the drawings, the circuit board 18 is illustrated as a block.

As shown in FIG. 2, in the display 20 of the display apparatus 100 according to the present embodiment, two protrusions 4c for determining intervals between components of the backlight housed in the chassis 4 are on a side face 4b of the chassis 4. Thereby, an interval between the liquid crystal panel 9 and the diffusion sheet 14, and an interval between the luminance improvement sheet 15 and the light guide plate 13 are set to predetermined values, and therefore light emitted to the rear face of the liquid crystal panel 9 is made more uniform. Note that, in the example of the present embodiment, the two luminance improvement sheets 15 and the one diffusion sheet 14 are stacked. However, detailed designs, such as, the numbers of the diffusion sheets and the luminance improvement sheets, the order of arrangement, the intervals of arrangement, the configuration of arrangement of optical sheets (e.g., whether to use another optical sheet), and the shape, material, thickness of the light guide plate may be appropriately selected based on well-known techniques for more uniforming illumination light emitted from the backlight to the rear face of the liquid crystal panel. Further, in the example of the present embodiment, the edge light type backlight in which light from a light source enters through a side of the light guide plate is used. However, the backlight may be a back side illumination type back light in which an LED light source is situated opposite to a rear face of a liquid crystal panel. In this case, so-called active backlight which changes colors and luminance of illumination light for each region of a liquid crystal panel in accordance with an image displayed on the liquid crystal panel may be used. Alternatively, a light source used as a backlight is not limited to an LED described above, but may be a fluorescent lamp or a semiconductor laser.

The glass cover 2 is situated in front of the liquid crystal panel 9. For example, the glass cover 2 may be made of a plate of 4 mm in thickness of physically tempered glass. Note that, as the glass cover of the display device according to the present disclosure, various types of glass such as float glass and chemically tempered glass may be used instead of the physically tempered glass. Further, a thickness of a glass plate used as the glass cover should be determined based on a size (area) of the glass cover and a location of the display device. However, for example, such a thickness may be in a range of 1 to 20 mm. Further, the glass cover may be made of hard transparent resin material which is conventionally used as an alternative to glass, such as polycarbonate which has substantially the same transparency and stiffness as glass. In this regard, the glass cover in the present description is not limited to being made of glass material in a strict sense. Further, the glass cover is not limited to being clear and colorless. For example, clear and colored glass, or so-called frosted glass which causes scattered reflection due to its uneven surface can be used to the extent that visual effects caused by an image displayed on the display panel is not prevented perfectly.

As shown in FIG. 1 and FIG. 2, a black frame 3 is formed by printing on a periphery of an inner face of the glass cover 2. As shown in FIG. 2, due to the black frame 3 formed in the periphery of the glass cover, the chassis 4 which holds the liquid crystal panel 9 and the backlight integrally to constitute the display module is concealed from the front side. Therefore, the black frame 3 serves as an escutcheon frame for improving visual impression for viewers.

Further, in the display device of the present embodiment, for example, a spacer 6 made of a transparent acrylic adhesive tape of 2 mm in thickness bonds a front end face 4e which is a surface of a front end 4d of the chassis 4 positioned opposite to the liquid crystal panel 9 to cover a periphery of a surface of the liquid crystal panel 9 and the glass cover 2 so that the front end face 4e and the glass cover 2 are spaced at a predetermined interval. The glass cover 2 protects a display screen of the liquid crystal panel 9.

In the display device used in the display apparatus 100 according to the present embodiment, the spacer 6 is disposed to cover an entire periphery of the glass cover 2, and thereby the glass cover 2 and the front end face 4e of the chassis 4 of the display 20 are spaced at a predetermined interval and are bonded together at their entire peripheries. As a result, as shown in FIG. 3, an airtight space 30 which is surrounded by the glass cover 2, the liquid crystal panel 9, an inner side face 4f of the chassis 4, and the spacer 6 is formed. In the display device of the present embodiment, air in the space 30 is substituted by dry air and thereby is in a dried state.

Note that, in the display device of the present disclosure, the airtight space 30 means a space enclosed to an extent that dry air inside the space 30 is not mixed with outside air. Hereinafter, in the present description, the phrase “the space 30 is in the airtight state” is used, and the expression “airtight state” in this phrase means that “state in which enclosure is made to an extent that inside air is not mixed with outside air”. Therefore, for example, there is no need to realize high airtightness like a discharging space of a plasma display panel which is made to be high vacuum by evacuation so as to allow fine discharging to occur inside. Hence, the airtight state in the sense of the present description also includes a state obtained by bonding peripheries of two glass plates with an adhesive tape.

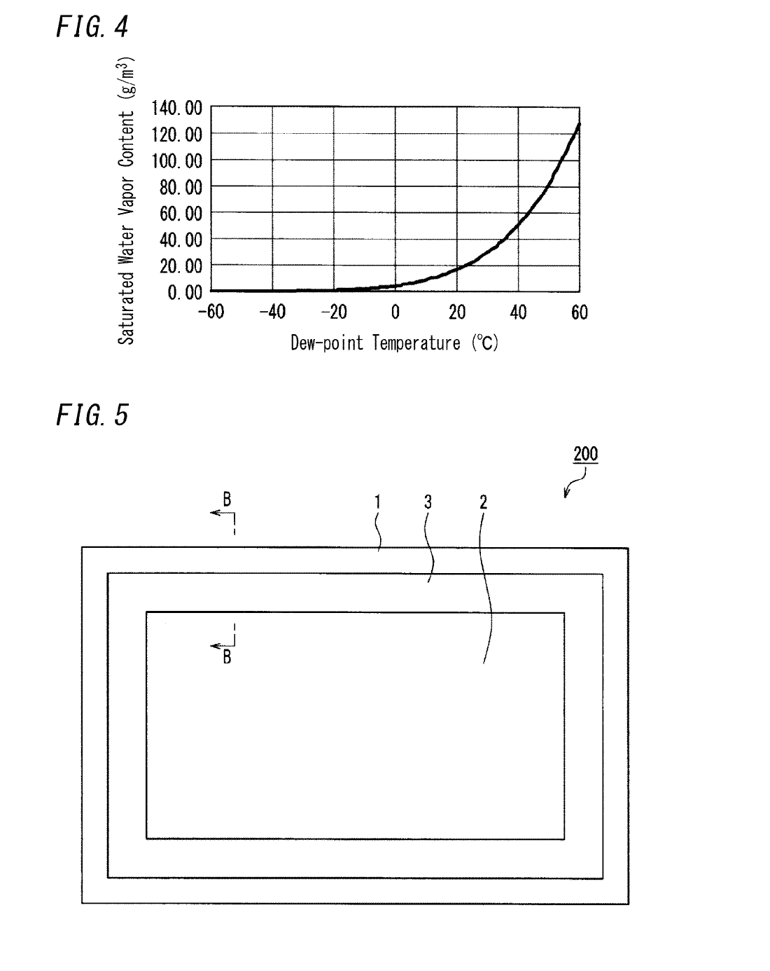

FIG. 4 shows a relation between a dew-point temperature and a saturated water vapor content of dry air.

The dry air used in the display device of the present disclosure is not required to have a low dew point which is not higher than −50° C. and have a higher cleanliness level to an extent of clean dry air (CDA) used in manufacturing processes of semiconductors or secondary batteries. It is possible to use air which has a dew point temperature which does not allow dew condensation in the space 30 even when the display device is used under the severest low temperature condition. For example, it is possible to use air having a dew point temperature in a range of 0° C. to −60° C. for atmospheric pressure. Further, the dry state in the present description means a state in which air has a dew point temperature which is not higher than 0° C. and is preferably not higher than −20° C. Such dry air can be prepared with an air dryer, for example.

Note that, a method of substituting substance inside the space 30 with dry air may be a method of hermetically enclosing the space 30 by steps of; using a member in which a not-shown through hole for air exchange is formed at a corner of the spacer 6; exchanging the air inside the space 30 for the dry air through this through hole; thereafter closing this through hole with a lid of resin; and covering this lid with a sealing member. Alternatively, by a method of exchanging the air inside the space 30 for the dry air and then closing the through hole with curable sealing material with a predetermined viscosity such as silicone resin and curing the same, it is possible to make the inside of the space 30 to be in the dry state. Note that, in the process of exchanging the air inside the space 30, mixed gas of inactive gas with lower water vapor content and air can be injected into the space 30 as an alternative to part or whole of the dry air. In this case, the inactive gas may be nitrogen or argon which is inactive against a chemical reaction or a substance, for example.

Further, as shown in FIG. 2, in the display apparatus 100 according to the present embodiment, when the display device in which the glass cover 2 and the display 20 are fixed with the spacer 6 to form a single part is accommodated in a glass cover holder 1a at a front side of the cabinet 1, the glass cover 2 is fixed to the cabinet 1 with seals 11 in-between. Due to this configuration, as shown in FIG. 3, a space 40 surrounded by the glass cover 2, the cabinet 1, and a side face and a rear face of the display 20 is airtight, and thus outside moisture is prevented from intruding into this space 40. By doing so, the space 30 between the glass cover 2 and the liquid crystal panel 9 is doubly isolated from an external environment, and thus it is possible to keep the space 30 be in the dry state more reliably.

As described above, in the display apparatus 100 according to the present embodiment, the glass cover 2 and the chassis 4 are bonded with the spacer 6, and dry air is injected, through a through hole formed in the spacer 6, into the space 30 surrounded by the glass cover 2, the liquid crystal panel 9, the chassis 4, and the spacer 6, and thereafter, this through hole is closed. By doing so, in the display apparatus 100 of the present embodiment, air inside the space 30 surrounded by the glass cover 2 of the display device, the liquid crystal display panel 9, the inner side face 4f of the chassis 4, and the spacer 6 can be kept in the dry state. Therefore, even if an external environment of the display apparatus 100 changes (e.g., an external temperature becomes lower than a temperature of the space 30 inside the display device and as a result a dew-point temperature of air inside the space 30 decreases), it is possible to prevent occurrence of dew condensation or reduce probability of occurrence of dew condensation.

### Embodiment 2

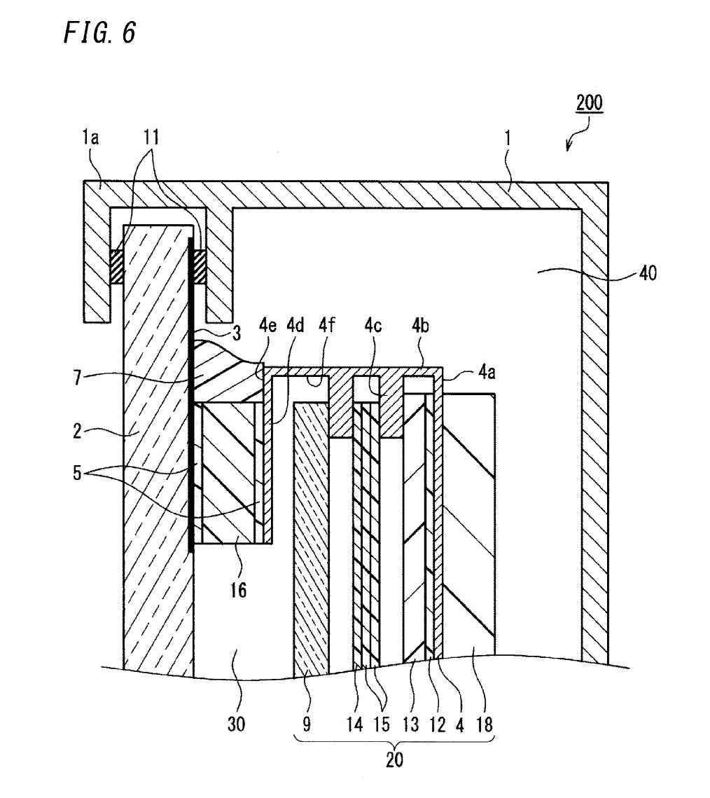

Hereinafter, as Embodiment 2 of the display device according to the present disclosure, a display apparatus including a display device is described with reference to FIG. 5 and FIG. 6.

FIG. 5 is a plan illustrating a whole structure of the display apparatus 200 according to Embodiment 2. FIG. 6 is a section illustrating the structure of the display apparatus 200 of Embodiment 2, and in particular is an enlarged section along line B-B in FIG. 5. Note that, the display apparatus 200 according to Embodiment 2 described with reference to FIG. 5 and FIG. 6 is different from the display apparatus 100 according to Embodiment 1 described with reference to FIG. 1 to FIG. 3 in only the configuration of the spacer bonding the glass cover and the display serving as the display unit. Therefore, to abbreviate or omit redundant explanations appropriately, the same components other than the spacer are designated by the same reference signs.

As shown in FIG. 5 and FIG. 6, in the display apparatus 200 according to the present embodiment, a glass cover 2 and a display 20 serving as a display module are arranged in this order from the front side of the display apparatus 200, and are accommodated in a cabinet 1.

The display 20 is same as the display of Embodiment 1, and also in the present embodiment is exemplified by a liquid crystal display including an edge light type backlight. In the display 20, a liquid crystal panel 9, a diffusion sheet 14 exemplifying an optical sheet, two luminance improvement sheets 15, a light guide plate 13, and a reflection sheet 12 are arranged inside a metal chassis 4 in this order with protrusions 4c for ensuring arrangement intervals in-between. Note that, an LED serving as a light source for emitting light to the light guide plate 13 is not illustrated. Further, a circuit board 18 is mounted on a rear face 4a of the chassis 4. On the circuit board 18, electronic parts for constituting a drive circuit are mounted. The drive circuit drives and controls the liquid crystal panel and the backlight to display an image.

As for the glass cover 2, a black frame 3 serving as an escutcheon frame is printed on a periphery of an inner face of the glass cover 2. The glass cover 2 is situated in front of the liquid crystal panel 9 to protect a display surface of the liquid crystal panel 9.

The display apparatus 200 of the present embodiment includes a spacer 16 for bonding a front end face 4e of a front end 4d of the chassis 4 positioned opposite to the liquid crystal panel 9 and the glass cover 2 so that the front end face 4e and the glass cover 2 are spaced at a predetermined interval. For example, the spacer 16 is made of an aluminum block of 5 mm in thickness. The spacer 16 is bonded to the front end face 4e of the chassis 4 with adhesive 5 in-between, and is bonded to the glass cover 2 with adhesive 5 in-between, and such adhesive 5 may be of butyl rubber. Due to this configuration, in the display apparatus 200 of the present embodiment, an airtight space 30 is formed as a space surrounded by the glass cover 2, the liquid crystal panel 9, the spacer 16, and an inner side face 4f of the chassis 4. For example, air inside this space 30 is substituted by dry air with a dew point temperature not higher than −20° C., and thereby the inside of the space 30 is made to be in a dry state.

Further, in the display apparatus 200 according to the present embodiment, after the air inside the space 30 is replaced by the dry air, an outside of the spacer 16 is hermetically surrounded by a spacer sealing member 7. By hermetically surrounding the outside of the spacer 16 with the spacer sealing member 7, airtightness of the space 30 can be improved.

Also in the display apparatus 200 according to the present embodiment, as shown in FIG. 6, in a process of accommodating the glass cover 2 in a glass cover holder 1a of the cabinet 1, the glass cover 2 is fixed to the cabinet 1 with seals 11 in-between. Due to this configuration, a space 40 surrounded by a side face and a rear face of the display 20 and the cabinet 1 is airtight, and thus outside moisture is prevented from intruding into this space 40. Therefore, the space 30 between the glass cover 2 and the liquid crystal panel 9 is doubly isolated from an external environment, and thus it is possible to keep the space 30 be in the dry state reliably.

As described above, in the display apparatus 200 including the display device according to the present embodiment, the spacer 16 is made of material having a stiffness of more than a certain level such as an aluminum block. Consequently, it is possible to keep the interval between the glass cover 2 and the liquid crystal panel 9 constant. Additionally, the outside of the spacer 16 is covered with the spacer sealing member 7. Hence, the space 30 surrounded by the glass cover 2, the liquid crystal panel 9, and the side face 4f of the chassis 4 can be successfully made to be more airtight, and thus the dry state of the space 30 can be maintained. Therefore, even if an external environment of the display apparatus 200 changes (e.g., a dew-point temperature of air inside the space 30 decreases), it is possible to prevent occurrence of dew condensation or reduce probability of occurrence of dew condensation.

### Embodiment 3

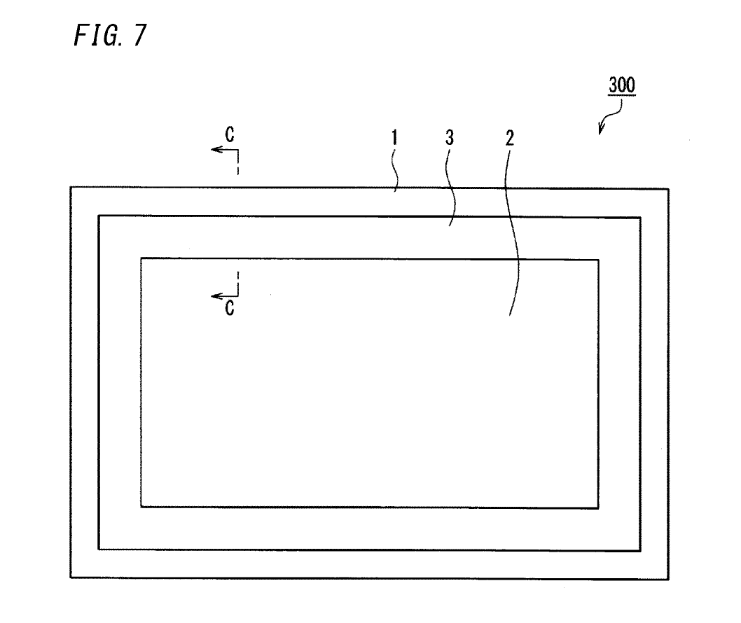

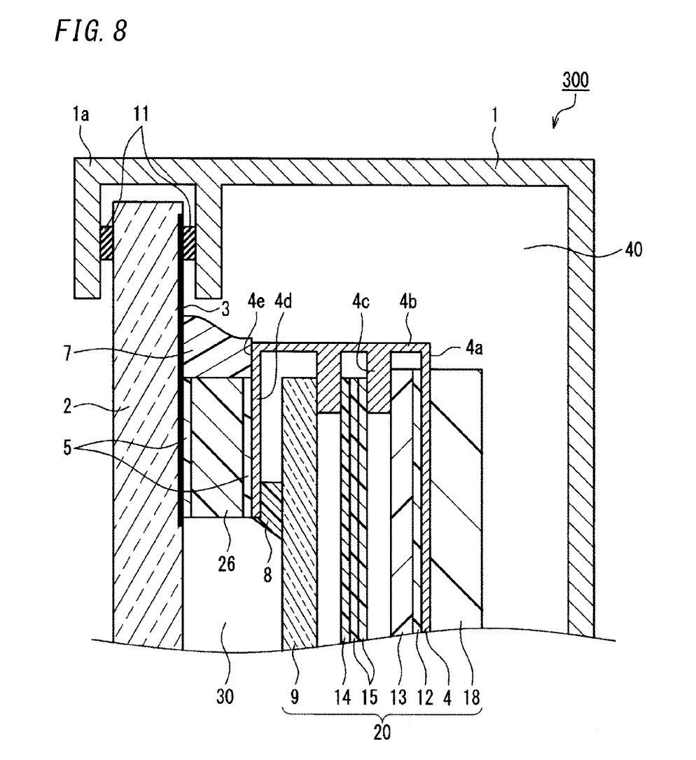

Hereinafter, as Embodiment 3 of the display device according to the present disclosure, a display apparatus including a display device is described with reference to FIG. 7 and FIG. 8.

FIG. 7 is a plan illustrating a whole structure of the display apparatus 300 including the display device according to Embodiment 3. FIG. 8 is a section illustrating the structure of the display apparatus 300 according to the present embodiment, and in particular is a section along line C-C in FIG. 7.

The display apparatus 300 according to Embodiment 3 described with reference to FIG. 7 and FIG. 8 includes a display panel sealing member 8 as shown in FIG. 8, in addition to the same components as the display apparatus 200 according to Embodiment 2 described with reference to FIG. 5 and FIG. 6. Therefore, to abbreviate or omit redundant explanations appropriately, components common to the display apparatus according to the present embodiment and the display apparatus 200 according to Embodiment 2 are designated by the same reference signs.

As shown in FIG. 7 and FIG. 8, in the display apparatus 300 according to the present embodiment, a glass cover 2 and a display 20 serving as a display module are arranged in this order from the front side of the display apparatus 300, and are accommodated in a cabinet 1.

The display 20 is exemplified by a liquid crystal display module including an edge light type backlight. A liquid crystal panel 9, a diffusion sheet 14 exemplifying an optical sheet, two luminance improvement sheets 15, a light guide plate 13, and a reflection sheet 12 are arranged inside a metal chassis 4 in this order with protrusions 4c in-between. Note that, an LED serving as a light source for emitting light to the light guide plate 13 is not illustrated. Further, a circuit board 18 is mounted on a rear face 4a of the chassis 4. On the circuit board 18, electronic parts for constituting a drive circuit are mounted. The drive circuit drives and controls the liquid crystal panel and the backlight to display an image.

As for the glass cover 2, a black frame 3 serving as an escutcheon frame is printed on a periphery of an inner face of the glass cover 2. The glass cover 2 is situated in front of the liquid crystal panel 9 to protect a display surface of the liquid crystal panel 9.

The display apparatus 300 of the present embodiment includes a spacer 26 for bonding a front end face 4e of a front end 4d of the chassis 4 positioned opposite to the liquid crystal panel 9 and the glass cover 2 so that the front end face 4e and the glass cover 2 are spaced at a predetermined interval. For example, the spacer 26 is made of an aluminum block with a section of 5 mm in width and of 8 mm in height. The spacer 26 is bonded to the front end face 4e of the chassis 4 with adhesive 5 in-between, and is bonded to the glass cover 2 with adhesive 5 in-between, and such adhesive 5 may be of butyl rubber.

Further, the display apparatus 300 of the present embodiment includes the display panel sealing member 8 situated between the front end 4d of the chassis 4 and the surface of the liquid crystal panel 9. As described above, a gap between the front end 4d of the chassis 4 and the surface of the liquid crystal panel 9 is sealed with the display panel sealing member 8 which is made of silicone resin, for example. Therefore, in the display apparatus 300 of the present embodiment, an airtight space 30 is formed as a space surrounded by the glass cover 2, the liquid crystal panel 9, the spacer 26, and the liquid crystal display panel sealing member 8. This space 30 has an outer limit defined by the display panel sealing member. After air inside this space 30 is substituted by dry air with a dew point temperature not higher than −20° C., an outside of the spacer 26 is hermetically surrounded by a spacer sealing member 7 made of silicone resin, for example.

As described above, in the display apparatus 300 of the present embodiment, the outside of the spacer 26 which defines the outer limit of the space 30 made to be in the dry state is hermetically enclosed by the spacer sealing member 7, and thereby the airtightness of the space 30 can be improved. Further, the gap between the front end 4d of the chassis 4 and the surface of the liquid crystal panel 9 is sealed with the display panel sealing member 8. Therefore, in contrast to a case where the display panel sealing member 8 is not used, the volume of the space 30 can be reduced, and therefore the airtightness of the space 30 can be more improved.

Note that, also in the display apparatus 300 according to the present embodiment, as shown in FIG. 8, in a process of accommodating the glass cover 2 in a glass cover holder 1a of the cabinet 1, the glass cover 2 is fixed to the cabinet 1 with seals 11 in-between. Due to this configuration, a space 40 surrounded by a side face and a rear face of the display 20 and the cabinet 1 is airtight, and thus outside moisture is prevented from intruding into this space 40. Therefore, the space 30 between the glass cover 2 and the liquid crystal panel 9 is doubly isolated from an external environment, and thus it is possible to keep the space 30 be in the dry state reliably.

As described above, in the display apparatus 300 including the display device according to the present embodiment, the outside of the spacer 26 is covered with the spacer sealing member 7 and the gap between the front end 4d of the chassis 4 and the surface of the liquid crystal panel 9 is sealed with the display panel sealing member 8. Therefore, the space 30 between the glass cover 2 and the liquid crystal panel 9 can be made to be airtight more reliably, and the space 30 can be made to be kept in the dry state. As a result, even if an external environment of the display apparatus 300 changes (e.g., a dew-point temperature of air inside the space 30 decreases), it is possible to prevent occurrence of dew condensation or reduce probability of occurrence of dew condensation.

### Embodiment 4

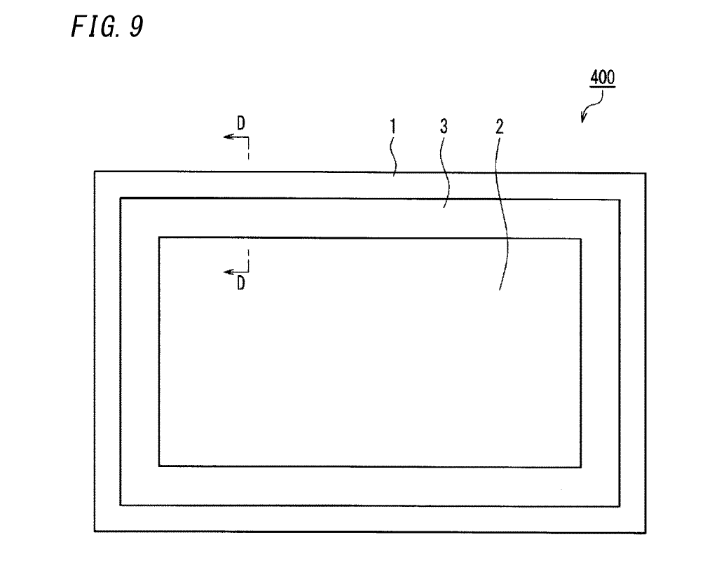

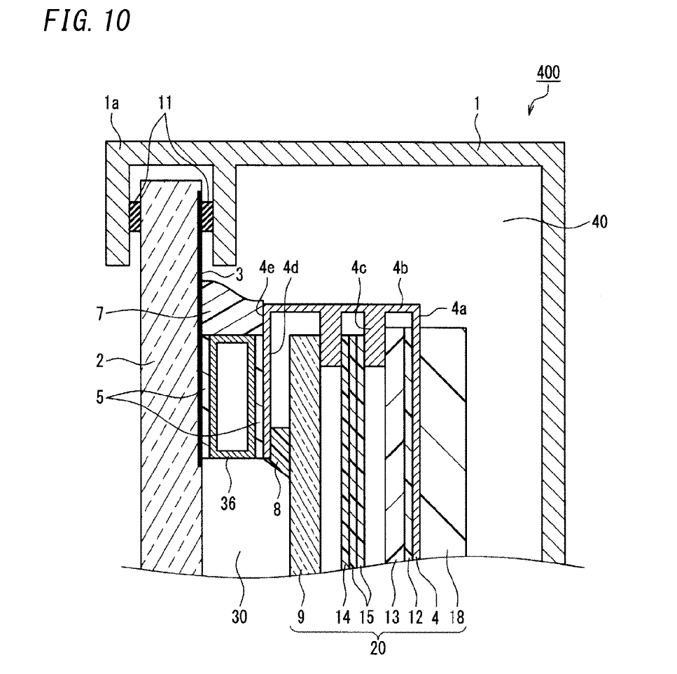

Hereinafter, as Embodiment 4 of the display device according to the present disclosure, a display apparatus including a display device is described with reference to FIG. 9 and FIG. 10.

FIG. 9 is a plan illustrating a whole structure of the display apparatus 400 according to Embodiment 4. FIG. 10 is a section illustrating the structure of the display apparatus 400 of Embodiment 4, and in particular is a section along line D-D in FIG. 9.

The display apparatus 400 according to Embodiment 4 described with reference to FIG. 9 and FIG. 10 is different from the display apparatus 300 according to Embodiment 3 described with reference to FIG. 7 and FIG. 8 in the structure of the spacer. Therefore, to abbreviate or omit redundant explanations appropriately, components common to the display apparatus according to the present embodiment and the display apparatus 300 according to Embodiment 3 are designated by the same reference signs.

As shown in FIG. 9 and FIG. 10, in the display apparatus 400 according to the present embodiment, a glass cover 2 and a display 20 serving as a display module are arranged in this order from the front side of the display apparatus 400, and these glass cover 2 and display 20 are accommodated in a cabinet 1.

The display 20 is exemplified by a liquid crystal display module including an edge light type backlight. A liquid crystal panel 9, a diffusion sheet 14 exemplifying an optical sheet, two luminance improvement sheets 15, a light guide plate 13, and a reflection sheet 12 are arranged inside a metal chassis 4 in this order with protrusions 4c in-between. Note that, an LED serving as a light source for emitting light to the light guide plate 13 is not illustrated. Further, a circuit board 18 is mounted on a rear face 4a of the chassis 4. On the circuit board 18, electronic parts for constituting a drive circuit are mounted. The drive circuit drives and controls the liquid crystal panel and the backlight to display an image.

As for the glass cover 2, a black frame 3 serving as an escutcheon frame is printed on a periphery of an inner face of the glass cover 2. The glass cover 2 is situated in front of the liquid crystal panel 9 to protect a display surface of the liquid crystal panel 9.

The display apparatus 400 according to the present embodiment includes a spacer 36 for bonding a front end face 4e of a front end 4d of the chassis 4 positioned opposite to the liquid crystal panel 9 and the glass cover 2 so that the front end face 4e and the glass cover 2 are spaced at a predetermined interval. For example, the spacer 36 is made of an aluminum rectangular pipe with a section of 5 mm in width and of 8 mm in height. The spacer 36 is bonded to the front end face 4e of the chassis 4 with adhesive 5 in-between, and is bonded to the glass cover 2 with adhesive 5 in-between, and such adhesive 5 may be of butyl rubber.

In the display apparatus 400 of the present embodiment, the gap between the front end 4d of the chassis 4 and the surface of the liquid crystal panel 9 is sealed with a display panel sealing member 8 which is made of silicone resin, for example. Therefore, in the display apparatus 400 of the present embodiment, an airtight space 30 is formed as a space surrounded by the glass cover 2, the liquid crystal panel 9, the spacer 36, and the display panel sealing member 8. After air inside this space 30 is substituted by dry air with a dew point temperature not higher than −20° C., an outside of the spacer 36 is hermetically surrounded by a spacer sealing member 7 made of silicone resin, for example.

As described above, in the display apparatus 400 according to the present embodiment, the outside of the spacer 36 which serves as an outer casing surrounding the space 30 made to be in the dry state is hermetically enclosed by the spacer sealing member 7, and thereby the airtightness of the space 30 can be improved. Further, the gap between the front end 4d of the chassis 4 and the surface of the liquid crystal panel 9 is sealed with the display panel sealing member 8. Therefore, in contrast to a case where the display panel sealing member 8 is not used, the volume of the space 30 can be reduced, and therefore the airtightness of the space 30 can be more improved. Further, in the display apparatus 400 of the present embodiment, the spacer 36 for keeping the predetermined interval between the glass cover 2 and the front end face 4d of the chassis is hollow. Hence, it is possible to decrease the weight of the display apparatus. Additionally, in a process of replacing the air inside the space 30 between the glass cover 2 and the liquid crystal panel 9 by the dry air to make the space 30 be in the dry state, it is possible to facilitate the formation of a through hole for replacement of air inside the space which penetrates the spacer 36.

Note that, also in the display apparatus 400 according to the present embodiment, as shown in FIG. 10, in a process of accommodating the glass cover 2 in a glass cover holder 1a of the cabinet 1, the glass cover 2 is fixed to the cabinet 1 with seals 11 in-between. Due to this configuration, a space 40 surrounded by a side face and a rear face of the display 20 and the cabinet 1 is airtight, and thus outside moisture is prevented from intruding into this space 40. Therefore, the space 30 between the glass cover 2 and the liquid crystal panel 9 is doubly isolated from an external environment, and thus it is possible to keep the space 30 be in the dry state reliably.

As described above, in the display apparatus 400 including the display device according to the present embodiment, the outside of the hollow spacer 26 is covered with the spacer sealing member 7 and the gap between the front end 4d of the chassis 4 and the surface of the liquid crystal panel 9 is sealed with the display panel sealing member 8. Therefore, it is possible to reduce the weight of the display apparatus, and the space 30 between the glass cover 2 and the liquid crystal panel 9 can be made to be airtight more reliably, and the space 30 can be made to be kept in the dry state. As a result, even if an external environment of the display apparatus 400 changes (e.g., a dew-point temperature of air inside the space 30 decreases), it is possible to prevent occurrence of dew condensation or reduce probability of occurrence of dew condensation.

### Embodiment 5

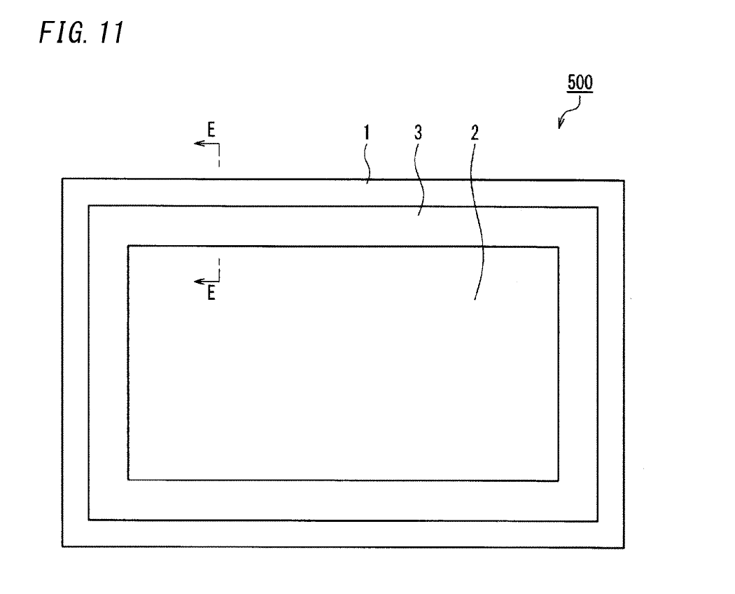

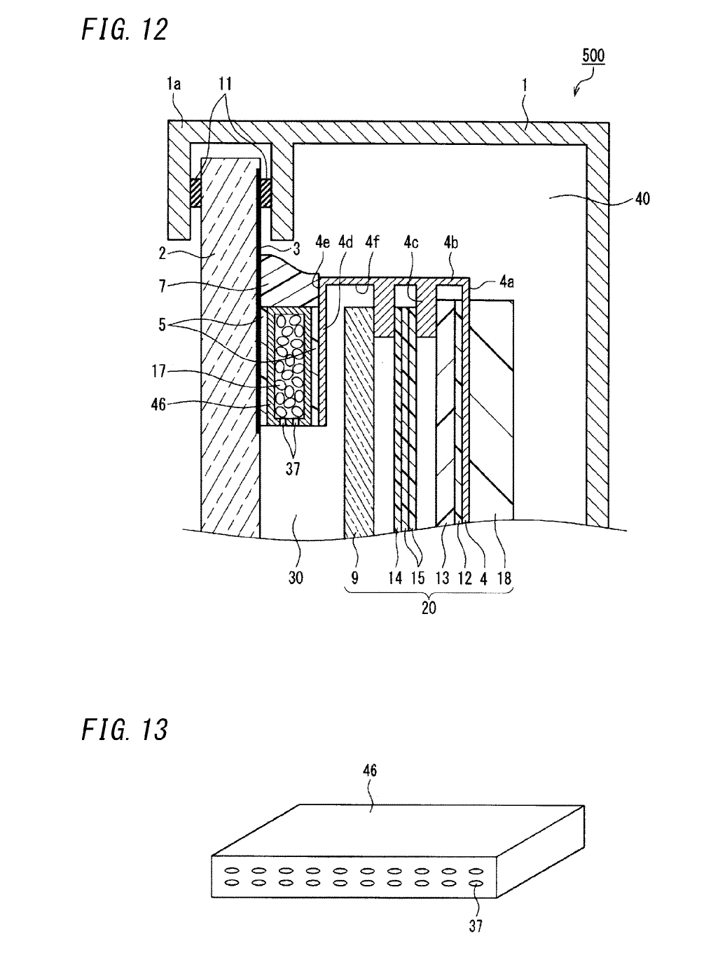

Hereinafter, as Embodiment 5 of the display device according to the present disclosure, a display apparatus including a display device is described with reference to FIG. 11 and FIG. 12.

FIG. 11 is a plan illustrating a whole structure of the display apparatus 500 according to Embodiment 5. FIG. 12 is a partially enlarged section illustrating the structure of the display apparatus 500 according to the present embodiment, and in particular is a section along line E-E in FIG. 11.

The display apparatus 500 according to Embodiment 5 described with reference to FIG. 11 and FIG. 12 is different from the display apparatus 200 according to Embodiment 2 described with reference to FIG. 5 and FIG. 6 in only the structure of the spacer. Therefore, to abbreviate or omit redundant explanations appropriately, components common to the display apparatus according to the present embodiment and the display apparatus 200 according to Embodiment 2 are designated by the same reference signs.

As shown in FIG. 11 and FIG. 12, in the display apparatus 500 according to the present embodiment, a glass cover 2 and a display 20 serving as a display module are arranged in this order from the front side of the display apparatus 500, and these glass cover 2 and display 20 are accommodated in a cabinet 1.

The display 20 is exemplified by a liquid crystal display including an edge light type backlight. A liquid crystal panel 9, a diffusion sheet 14 exemplifying an optical sheet, two luminance improvement sheets 15, a light guide plate 13, and a reflection sheet 12 are arranged inside a metal chassis 4 in this order with protrusions 4c in-between. Note that, an LED serving as a light source for emitting light to the light guide plate 13 is not illustrated. Further, a circuit board 18 is mounted on a rear face 4a of the chassis 4. On the circuit board 18, electronic parts for constituting a drive circuit are mounted. The drive circuit drives and controls the liquid crystal panel and the backlight to display an image.

As for the glass cover 2, a black frame 3 serving as an escutcheon frame is printed on a periphery of an inner face of the glass cover 2. The glass cover 2 is situated in front of the liquid crystal panel 9 to protect a display surface of the liquid crystal panel 9.

The display apparatus 500 according to the present embodiment includes a spacer 46 for bonding a front end face 4e of a front end 4d of the chassis 4 positioned opposite to the liquid crystal panel 9 and the glass cover 2 so that the front end face 4e and the glass cover 2 are spaced at a predetermined interval. For example, the spacer 46 is made of an aluminum block with a section of 5 mm in width and of 8 mm in height. The spacer 46 is bonded to the front end face 4e of the chassis 4 with adhesive 5 in-between, and is bonded to the glass cover 2 with adhesive 5 in-between, and such adhesive 5 may be of butyl rubber.

In the display apparatus 500 of the present embodiment, an airtight space 30 is formed as a space surrounded by the glass cover 2, the liquid crystal panel 9, the spacer 46, and the inner side face 4f of the chassis 4. For example, air inside this space 30 is substituted by dry air with a dew point temperature not higher than −20° C. by use of a through hole for replacement of air (not shown) formed at a corner of the spacer 46, and thereafter the through hole for replacement of air is closed. Thus, the space 30 is made to be in the dry state.

Further, in the display apparatus 500 of the present embodiment, after air inside this space 30 is substituted by dry air, an outside of the spacer 46 is hermetically surrounded by a spacer sealing member 7 made of silicone resin, for example. The outside of the spacer 46 is hermetically enclosed by the spacer sealing member 7, and thereby the airtightness of the space 30 can be improved.

Hereinafter, the spacer 46 is described in more detail.

FIG. 13 is a perspective view of the spacer 46 used in the display apparatus 500 according to the present embodiment, when viewed from the space 30 which is a space formed between the glass cover 2 and the liquid crystal panel 9.

In FIG. 13, the upper surface of the spacer 46 is directed to the glass cover 2, that is, the front side of the display apparatus 500, and the lower surface of the spacer 46 is directed to the liquid crystal panel 9, that is, the rear side of the display apparatus 500. Further, the front face of the spacer 46 faces the space 30.

As shown in FIG. 12 and FIG. 13, the spacer 46 used in the display apparatus 500 according to the present embodiment includes fine holes 37 formed in a surface facing the space 30, and thus the space 30 is allowed to be connected to a hollow space formed inside the spacer 46. This hollow space is filled with desiccant 17. The holes 37 formed in the surface of the spacer 46 have a size smaller than a particle size of the desiccant 17 in order to prohibit the desiccant 17 from entering the space 30 via the hole 37. The desiccant 17 may be selected from zeolite, molecular sieve, and silica gel, for example. Note that, the desiccant for filling the hollow space of the spacer may not be limited to being formed into particles as shown in FIG. 12, but may be formed into a sheet, or a bar. In a case of using the desiccant formed into a sheet or a bar, the holes formed in the side face of the spacer can be enlarged to an extent that the desiccant does not enter the space between the glass cover and the liquid crystal panel from the hollow space of the spacer. The holes formed in the side face of the spacer may be separate holes or a single continuous hole.

Note that, also in the display apparatus 500 according to the present embodiment, as shown in FIG. 12, in a process of accommodating the glass cover 2 in a glass cover holder 1a of the cabinet 1, the glass cover 2 is fixed to the cabinet 1 with seals 11 in-between. Due to this configuration, a space 40 surrounded by a side face and a rear face of the display 20 and the cabinet 1 is airtight, and thus outside moisture is prevented from intruding into this space 40. Therefore, the space 30 between the glass cover 2 and the liquid crystal panel 9 is doubly isolated from an external environment, and thus it is possible to keep the space 30 be in the dry state reliably.

As described above, in the display apparatus 500 including the display device according to the present embodiment, the outside of the spacer 46 is covered with the spacer sealing member 7. Further, the spacer 46 includes one or more holes 37 in the face facing the space 30 between the glass cover 2 and the liquid crystal panel 9, and the hollow space inside the spacer 46 which is connected to the space 30 via the hole 37 is filled with the desiccant 17. Therefore, it is possible to keep the dry state of the space 30 between the glass cover 2 and the liquid crystal panel 9. Even if an external environment of the display apparatus 500 changes (e.g., a dew-point temperature of air inside the space 30 decreases), it is possible to prevent occurrence of dew condensation effectively.

### Embodiment 6

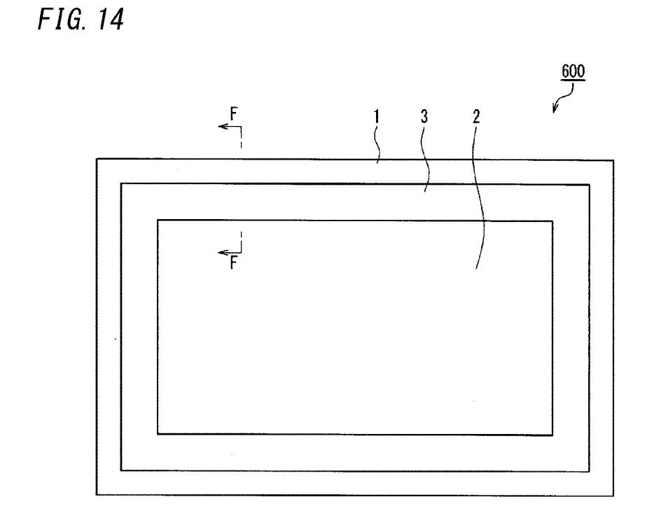

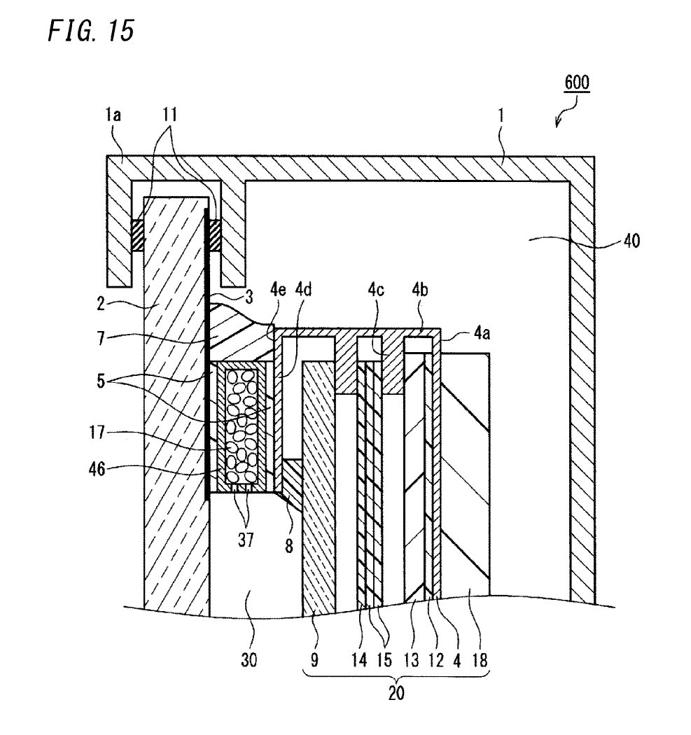

Hereinafter, as Embodiment 6 of the display device according to the present disclosure, a display apparatus including a display device is described with reference to FIG. 14 and FIG. 15.

FIG. 14 is a plan illustrating a whole structure of the display apparatus 600 according to Embodiment 6. FIG. 15 is an enlarged section illustrating the structure of the display apparatus 600 according to the present embodiment, and in particular is a section along line F-F in FIG. 14.

Note that, the display apparatus 600 according to Embodiment 6 described with reference to FIG. 14 and FIG. 15 includes a display panel sealing member 8 in addition to the same components as the display apparatus 5 according to Embodiment 5 described with reference to FIG. 11 to FIG. 13.

As shown in FIG. 14 and FIG. 15, in the display apparatus 600 according to the present embodiment, a glass cover 2 and a display 20 serving as a display module are arranged in this order from the front side of the display apparatus 600, and are accommodated in a cabinet 1.

The display 20 is exemplified by a liquid crystal display module including an edge light type backlight. A liquid crystal panel 9, a diffusion sheet 14 exemplifying an optical sheet, two luminance improvement sheets 15, a light guide plate 13, and a reflection sheet 12 are arranged inside a metal chassis 4 in this order with protrusions 4c in-between. Note that, an LED serving as a light source for emitting light to the light guide plate 13 is not illustrated. Further, a circuit board 18 is mounted on a rear face 4a of the chassis 4. On the circuit board 18, electronic parts for constituting a drive circuit are mounted. The drive circuit drives and controls the liquid crystal panel and the backlight to display an image.

As for the glass cover 2, a black frame 3 serving as an escutcheon frame is printed on a periphery of an inner face of the glass cover 2. The glass cover 2 is situated in front of the liquid crystal panel 9 to protect a display surface of the liquid crystal panel 9. The display apparatus 600 of the present embodiment includes a spacer 46 for bonding a front end face 4e of a front end 4d of the chassis 4 positioned opposite to the liquid crystal panel 9 and the glass cover 2 so that the front end face 4e and the glass cover 2 are spaced at a predetermined interval. For example, the spacer 46 is made of an aluminum rectangular pipe with a section of 5 mm in width and of 8 mm in height. The spacer 46 is bonded to the front end face 4c of the chassis 4 with adhesive 5 in-between, and is bonded to the glass cover 2 with adhesive 5 in-between, and such adhesive 5 may be of butyl rubber.

In the display apparatus 600 of the present embodiment, a gap between the front end 4d of the chassis 4 and the surface of the liquid crystal panel 9 is sealed with the display panel sealing member 8 which is made of silicone resin, for example. Therefore, in the display apparatus 600 of the present embodiment, an airtight space 30 is formed as a space surrounded by the glass cover 2, the liquid crystal panel 9, the spacer 46, and the display panel sealing member 8. After air inside this space 30 is substituted by dry air with a dew point temperature not higher than −20° C., an outside of the spacer 46 is hermetically surrounded by a spacer sealing member 7 made of silicone resin, for example.

The display apparatus 600 of the present embodiment includes the spacer 46 shown in FIG. 13. As shown in FIG. 13 and FIG. 15, the spacer 46 includes fine holes 37 formed in a surface facing the space 30, and thus the space 30 is allowed to be connected to a hollow space which is formed inside the spacer 46 and is filled with a desiccant 17. The desiccant 17 may be selected from zeolite, molecular sieve, and silica gel, for example.

Note that, also in the display apparatus 600 according to the present embodiment, as shown in FIG. 15, in a process of accommodating the glass cover 2 in a glass cover holder 1a of the cabinet 1, the glass cover 2 is fixed to the cabinet 1 with seals 11 in-between. Due to this configuration, a space 40 surrounded by a side face and a rear face of the display 20 and the cabinet 1 is airtight, and thus outside moisture is prevented from intruding into this space 40. Therefore, the space 30 between the glass cover 2 and the liquid crystal panel 9 is doubly isolated from an external environment, and thus it is possible to keep the space 30 be in the dry state reliably.

As described above, in the display apparatus 600 of the present embodiment, the outside of the spacer 46 which defines an outer limit of the space 30 made to be in the dry state is hermetically surrounded by the spacer sealing member 7, and therefore the airtightness of the space 30 can be improved. Further, the gap between the front end 4d of the chassis 4 and the surface of the liquid crystal panel 9 is sealed with the display panel sealing member 8. Therefore, in contrast to a case where the display panel sealing member 8 is not used, the volume of the space 30 can be reduced, and therefore the airtightness of the space 30 can be more improved. Additionally, in the display apparatus 600 according to the present embodiment, the spacer 46 includes one or more holes 37 in the face facing the space 30 between the glass cover 2 and the liquid crystal panel 9, and the hollow space inside the spacer 46 which is connected to the space 30 via the hole 37 is filled with the desiccant 17.

Therefore, it is possible to keep the dry state of the space 30 between the glass cover 2 and the liquid crystal panel 9. As a result, even if an external environment of the display apparatus 600 changes (e.g., a dew-point temperature of air inside the space 30 decreases), it is possible to prevent occurrence of dew condensation effectively.

### Embodiment 7

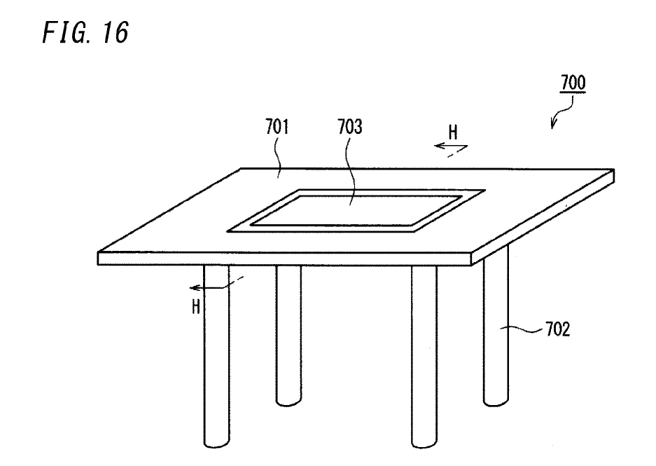

Hereinafter, Embodiment 7 of the display device of the present disclosure is described with reference to FIG. 16 to FIG. 18. The display device of the present embodiment shows a usage example of the first application of the display device of the present disclosure, and relates to a table including the built-in display device.

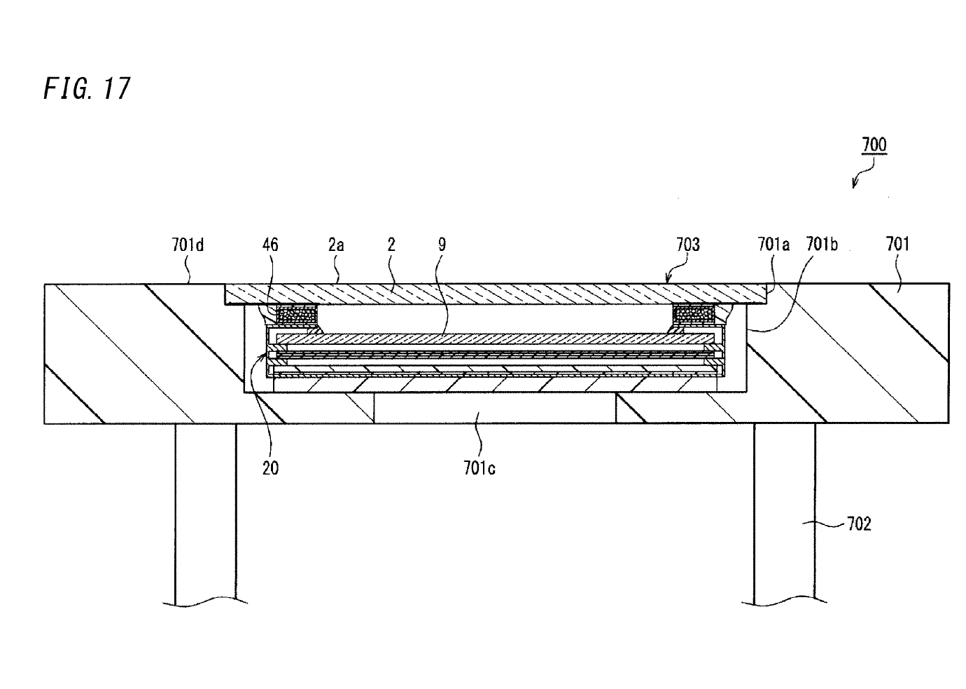

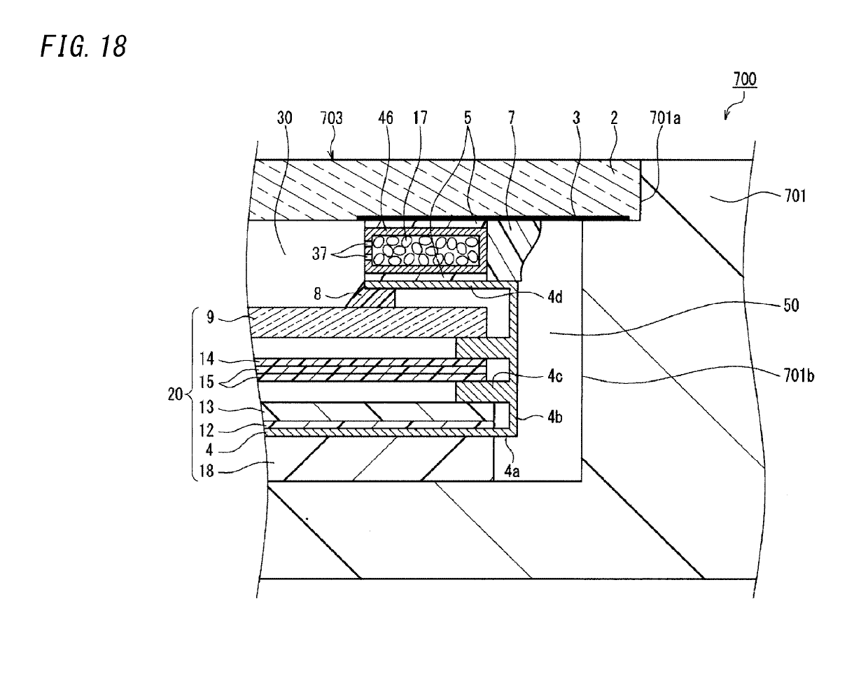

FIG. 16 is a perspective view illustrating a whole structure of a table 700 including the built-in display device according to Embodiment 7. FIG. 17 is a section illustrating the structure of the table 700 according to the present embodiment, and in particular is a section along line H-H in FIG. 16. FIG. 18 is an enlarged section illustrating the display device embedded in the table 700 according to the present embodiment and surroundings thereof.

Note that, the configurations of a glass cover, a spacer, and a display serving as a display module which constitute the display device of the table 700 according to Embodiment 7 are same as those of the display device used in the display apparatus 600 according to Embodiment 6 described with reference to FIG. 14 and FIG. 15. Therefore, in the following description about the table 700 according to the present embodiment, to abbreviate or omit redundant explanations appropriately, components common to the display apparatus according to the present embodiment and the display apparatus 600 are designated by the same reference signs.

As shown in FIG. 16 and FIG. 17, the table 700 including the built-in display device 703 according to the present embodiment further includes a top board 701, and four legs 702 connected to the top board 701. In a central part of the top board 701, the display device 703 is situated so that an image display surface of the display device 703 is directed upward.

The top board 701 and the legs 702 of the table 700 of the present embodiment may be made of one or more of various types of materials used for top boards and legs of tables such as glass, hard resin, wood, and metal.

In the central part of the top board 701, a first recess 701a and a second recess 701b are formed. The first recess 701a is relatively shallow. The second recess 701b is formed in a bottom of the first recess 701a. The second recess 701b has a smaller opening than the first recess 701a, and is deeper than the first recess 701a. Note that, the top board 701 of the table of the present embodiment includes a through hole 701c penetrating through the top board 701 at the central part of the bottom of the second recess 701b.

In the table 700 of the present embodiment, the glass cover 2 of the display device 703 is accommodated in the first recess 701a of the top board 701, and a surface 2a of the glass cover 2 is positioned at the same height as a surface 701d of the top board 701. Further, the display 20 which is bonded to a rear face of the glass cover 2 of the display device 703 by use of a spacer 46 is accommodated in the second recess 701b formed in the top board 701. By doing so, it is possible to realize the table 700 including the built-in display device according to the present embodiment, and the table 700 is a table including the top board 701 having its flat upper face and nevertheless allows displaying images.

Note that, it is preferable that a size of the opening of the first recess 701a of the top board 701 match the outer shape of the glass cover 2 so that there is no clearance between the first recess 701a and the glass cover 2. A gap as an unavoidable margin for accommodating the glass cover 2 in the first recess 701a may be filled with appropriate sealant.

As shown in FIG. 18, the display 20 of the display unit 703 is exemplified by a liquid crystal display including an edge light type backlight. A liquid crystal panel 9, a diffusion sheet 14 exemplifying an optical sheet, two luminance improvement sheets 15, a light guide plate 13, and a reflection sheet 12 are arranged inside a metal chassis 4 in this order with protrusions 4c, which serve as spacers, in-between. Note that, an LED serving as a light source for emitting light to the light guide plate 13 is not illustrated. Further, a circuit board 18 is mounted on a rear face 4a of the chassis 4. On the circuit board 18, electronic parts for constituting a drive circuit are mounted. The drive circuit drives and controls the liquid crystal panel and the backlight to display an image.

Note that, as shown in FIG. 17, in the table 700 of the present embodiment, the through hole 701c is formed at the central part of the bottom of the second recess 701b of the top board 701 to extend to the rear face of the top board 701. Therefore, a central part of the circuit board 18 of the display 20 is exposed on the rear face of the top board 701. As described above, part of the circuit board 18 is exposed on the top board 701, and thus heat generated in the circuit board 18 is easily dissipated outside. Consequently, the liquid crystal panel 9 can display images stably for long time. Note that, exposing the circuit board 18 directly may be not preferable in view of safety and appearance. In view of this, the table 700 of the present embodiment includes a circuit board cover (not shown) for covering the circuit board 18, and the circuit board cover may be made of resin or metal. Further, when the circuit board cover for covering the circuit board 18 is provided, as shown in FIG. 17 and FIG. 18, the circuit board cover can be situated in contact with the bottom of the second recess 701b of the top board 701, and thereby the bottom of the second recess 701b of the top board 701 can carry the weight of the display 20.

As for the glass cover 2, a black frame 3 serving as an escutcheon frame is printed on a periphery of an inner face of the glass cover 2. The glass cover 2 is situated in front of the liquid crystal panel 9 to protect a display surface of the liquid crystal panel 9.

The table 700 of the present embodiment includes a spacer 46 for bonding a front end face 4e of a front end 4d of the chassis 4 positioned opposite to the liquid crystal panel 9 and the glass cover 2 so that the front end face 4e and the glass cover 2 are spaced at a predetermined interval. For example, the spacer 46 is made of an aluminum rectangular pipe with a section of 5 mm in width and of 8 mm in height. The spacer 46 is bonded to the front end face 4c of the chassis 4 with adhesive 5 in-between, and is bonded to the glass cover 2 with adhesive 5 in-between, and such adhesive 5 may be of butyl rubber.

In the table 700 of the present embodiment, a gap between the front end 4d of the chassis 4 and the surface of the liquid crystal panel 9 is sealed with the display panel sealing member 8 which is made of silicone resin, for example. Therefore, in the table 700 of the present embodiment, an airtight space 30 is formed as a space surrounded by the glass cover 2, the liquid crystal panel 9, the spacer 46, and the display panel sealing member 8. After air inside this space 30 is substituted by dry air with a dew point temperature not higher than −20° C., an outside of the spacer 46 is hermetically surrounded by a spacer sealing member 7 made of silicone resin, for example.

The table 700 of the present embodiment includes the spacer 46 shown in FIG. 13. As shown in FIG. 13 and FIG. 18, the spacer 46 includes fine holes 37 formed in a surface facing the space 30, and thus the space 30 is allowed to be connected to a hollow space which is formed inside the spacer 46 and is filled with a desiccant 17. The desiccant 17 may be selected from zeolite, molecular sieve, and silica gel, for example.

Note that, as described above, in the table 700 of the present embodiment, the circuit board 18 of the display device 703 is covered with the circuit board cover, and the rear face of the circuit board cover is in contact with the bottom of the second recess 701b of the top board 701. Due to this, in contrast to a configuration where the bottom of the first recess 701a of the top board 701 bears a periphery of the glass cover 2 to carry the weight of the display device 703 entirely, it is possible to avoid occurrence of force to remove the spacer 46 from the glass cover 2, and thus a decrease in the airtightness of the space 30 between the glass cover 2 and the liquid crystal panel 9 can be prevented. Further, the rear face of the circuit board cover is in contact with the bottom of the second recess 701b of the top board 701, and thereby a space 50 between the chassis 4 of the display device 703 and an inner face of the second recess 701b is hermetically enclosed, and therefore outside moisture cannot easily intrude into this space 50. As a result, it is possible to keep the space 30 between the glass cover 2 and the liquid crystal panel 9 in a fine dry state.

As described above, in the table 700 of the present embodiment, the outside of the spacer 46 which forms an outer casing surrounding the space 30 made to be in the dry state is hermetically surrounded by the spacer sealing member 7, and therefore the airtightness of the space 30 can be improved. Further, the gap between the front end 4d of the chassis 4 and the surface of the liquid crystal panel 9 is sealed with the display panel sealing member 8. Therefore, in contrast to a case where the display panel sealing member 8 is not used, the volume of the space 30 can be reduced, and therefore the airtightness of the space 30 can be more improved. Additionally, in the table 700 according to the present embodiment, the spacer 46 includes one or more holes 37 in the face facing the space 30 between the glass cover 2 and the liquid crystal panel 9, and the hollow space inside the spacer 46 which is connected to the space 30 via the hole 37 is filled with the desiccant 17. Therefore, it is possible to keep the dry state of the space 30 between the glass cover 2 and the liquid crystal panel 9. As a result, even if an external environment of the table 700 changes (e.g., a dew-point temperature of air inside the space 30 decreases), it is possible to prevent occurrence of dew condensation effectively.

### Embodiment 8

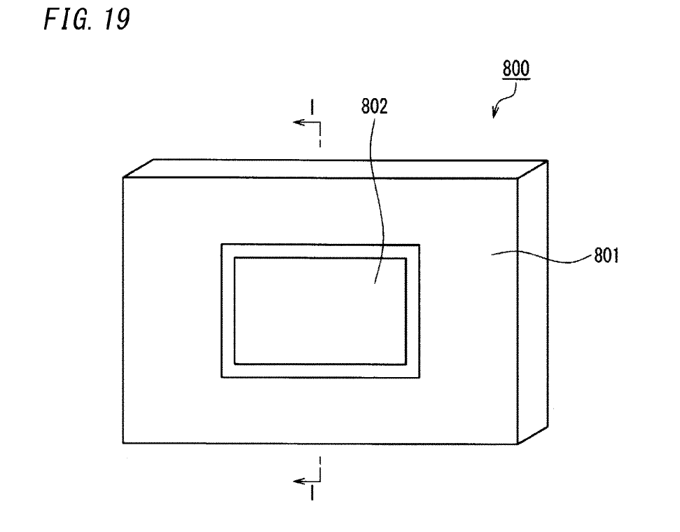

Hereinafter, Embodiment 8 of the display device of the present disclosure is described with reference to FIG. 19 to FIG. 21. The display device of the present embodiment shows a usage example of the second application of the display device of the present disclosure, and relates to a wall including the built-in display device.

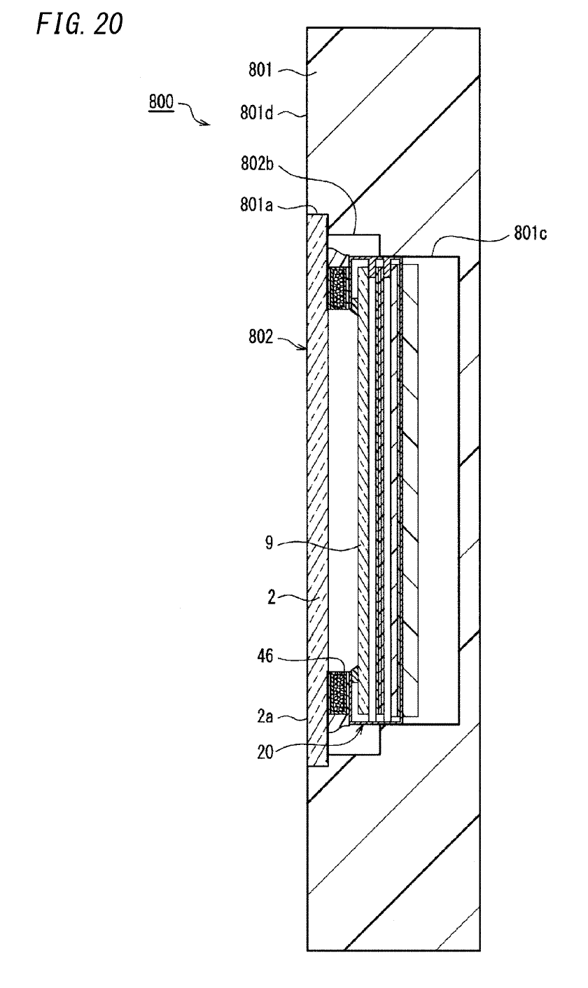

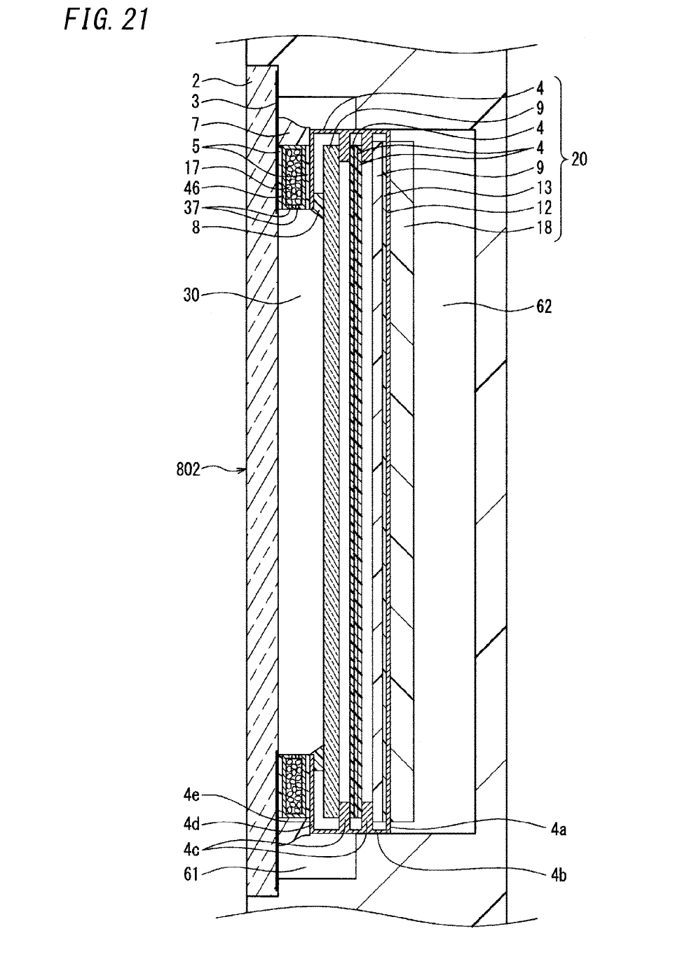

FIG. 19 is a perspective view illustrating a whole structure of a wall 800 including a built-in display device 802 according to Embodiment 8. FIG. 20 is a section illustrating the structure of the wall 800 according to the present embodiment, and in particular is a section along line I-I in FIG. 19. FIG. 21 is an enlarged section illustrating the display device 802 and surroundings of the display device 802 of the wall 800.

Note that, the configurations of a glass cover, a spacer, and a display serving as a display module which constitute the display device 802 of the wall 800 according to Embodiment 8 are same as those of the display device used in the display apparatus 600 according to Embodiment 6 described with reference to FIG. 14 and FIG. 15. Therefore, in the following description about the wall 800 according to the present embodiment, to abbreviate or omit redundant explanations appropriately, components common to the display apparatus according to the present embodiment and the display apparatus 600 are designated by the same reference signs.

As shown in FIG. 19 and FIG. 20, the wall 800 including the built-in display device according to the present embodiment further includes a wall body 801, and the display device 802 situated in a central part of the wall body 801 so that an image display surface of the display device 802 is directed forward.

The wall body 801 of the wall 800 of the present embodiment may be a fixed wall of a building, a displaying part of an indicator fixed to a ground or a floor, or a movable wall such as a partition with bottom rollers to be easily moved to a desired position. Hence, the wall body 801 may be made of: building material such as wooden board (e.g., plywood), a plaster board, a concrete board, and one of various types of stone materials; glass; hard resin such as reinforced plastics; and metal.

In the central part of the wall body 801, a first recess 801a, a second recess 801b, and a third recess 801c are formed. The first recess 801a is shallowest. The second recess 801b is formed in a bottom of the first recess 801a. The second recess 801b has a smaller opening than the first recess 801a, and is deeper than the first recess 801a. The third recess 801c is formed in a bottom of the second recess 801b. The third recess 801c has the smallest opening.

In the wall 800 of the present embodiment, the glass cover 2 of the display device 802 is accommodated in the first recess 801a of the wall body 801, and a surface 2a of the glass cover 2 is positioned at the same height as a surface 801d of the wall body 801. Further, the display 20 which is bonded to a rear face of the glass cover 2 of the display device 802 by use of a spacer 46 is accommodated in a space defined by the second recess 801b and the third recess 801c formed in the wall body 801. By doing so, it is possible to realize the wall 800 according to the present embodiment, and the wall 800 is a wall including the flat outer face and nevertheless allows displaying images.

Note that, it is preferable that a size of the opening of the first recess 801a of the wall body 801 match the outer shape of the glass cover 2 so that there is no clearance between the first recess 801a and the glass cover 2. A gap as an unavoidable margin for fitting the glass cover 2 into the first recess 801a may be filled with appropriate sealant.

As shown in FIG. 21, the display 20 of the display device 802 is exemplified by a liquid crystal display including an edge light type backlight. A liquid crystal panel 9, a luminance improvement sheet 15, two diffusion sheets 14 exemplifying optical sheets, a light guide plate 13, and a reflection sheet 12 are arranged inside a metal chassis 4 in this order with spacers 4c in-between. Note that, an LED serving as a light source for emitting light to the light guide plate is not illustrated. Further, a circuit board 18 is mounted on a rear face 4a of the chassis 4. On the circuit board 18, electronic parts for constituting a drive circuit are mounted. The drive circuit drives and controls the liquid crystal panel and the backlight.

As for the glass cover 2, a black frame 3 serving as an escutcheon frame is printed on a periphery of an inner face of the glass cover 2. The glass cover 2 is situated in front of the liquid crystal panel 9 to protect a display surface of the liquid crystal display 20.

The wall 800 of the present embodiment includes a spacer 46 for bonding a front end face 4e of a front end 4d of the chassis 4 positioned opposite to the liquid crystal panel 9 and the glass cover 2 so that the front end face 4e and the glass cover 2 are spaced at a predetermined interval. For example, the spacer 46 is made of an aluminum rectangular pipe with a section of 5 mm in width and of 8 mm in height. The spacer 46 is bonded to the front end face 4c of the chassis 4 with adhesive 5 in-between, and is bonded to the glass cover 2 with adhesive 5 in-between, and such adhesive 5 may be of butyl rubber.

In the wall 800 of the present embodiment, a gap between the front end 4d of the chassis 4 and the surface of the liquid crystal panel 9 is sealed with the display panel sealing member 8 which is made of silicone resin, for example. Therefore, in the table 700 of the present embodiment, an airtight space 30 is formed as a space surrounded by the glass cover 2, the liquid crystal panel 9, the spacer 46, and the display panel sealing member 8. After air inside this space 30 is substituted by dry air with a dew point temperature not higher than −20° C., an outside of the spacer 46 is hermetically surrounded by a spacer sealing member 7 made of silicone resin, for example.

The wall 800 according to the present embodiment includes the spacer 46 shown in FIG. 13. As shown in FIG. 13 and FIG. 21, the spacer 46 includes fine holes 37 formed in a surface facing the space 30, and thus the space 30 is allowed to be connected to a hollow space which is formed inside the spacer 46 and is filled with a desiccant 17. The desiccant 17 may be selected from zeolite, molecular sieve, and silica gel, for example.

As shown in FIG. 20 and FIG. 21, in the wall 800 of the present embodiment, a side face 4b of the chassis 4 of the display device 802 is in contact with a side face of the third recess 801c of the wall body 801. Due to this, in contrast to a configuration where only the glass cover 2 fitted in the first recess 801a of the wall body 801 carries the weight of the display device 802 entirely, it is possible to avoid occurrence of force to pull the spacer 46 obliquely downward caused by the weight of the display 20, and thus a decrease in the airtightness of the space 30 between the glass cover 2 and the liquid crystal panel 9 can be prevented.

Further, in the display device 802 of the present embodiment, the side face 4b of the chassis 4 of the display 20 is in contact with the side face of the third recess 801c of the wall body 801. Therefore, a side face space 61 inside the second recess 801b of the wall body 801 and a rear face space 62 inside the third recess 801c of the wall body 801 are isolated from an outside space of the wall body 801. Consequently, the side face space 61 and the rear face space 62 are hermetically enclosed, and hence outside moisture or the like cannot intrude into the space 61 or 62. As a result, the space 30 between the glass cover 2 and the liquid crystal panel 9 is successfully isolated from external environments, and therefore the dry state of the space 30 can be kept fine. Note that, in the wall 800 according to the present embodiment, a recess formed in the wall body 801 for accommodating the display device 802 is not limited to three recesses which are the first to third recesses described above. For example, as for such a recess, the aforementioned second recess and third recess may be formed as a single recess, and one or more protrusions to be in contact with the side face 4b of the chassis 4 to carry the weight of the chassis 4 may be provided to a side face of this single recess.

As described above, in the wall 800 of the present embodiment, the outside of the spacer 46 which forms an outer casing surrounding the space 30 made to be in the dry state is hermetically surrounded by the spacer sealing member 7, and therefore the airtightness of the space 30 can be improved. Further, the gap between the front end 4d of the chassis 4 and the surface of the liquid crystal panel 9 is sealed with the display panel sealing member 8. Therefore, in contrast to a case where the display panel sealing member 8 is not used, the volume of the space 30 can be reduced, and therefore the airtightness of the space 30 can be more improved. Additionally, in the wall 800 according to the present embodiment, the spacer 46 includes one or more holes 37 in the face facing the space 30 between the glass cover 2 and the liquid crystal panel 9, and the hollow space inside the spacer 46 which is connected to the space 30 via the hole 37 is filled with desiccant. Therefore, it is possible to keep the dry state of the space 30 between the glass cover 2 and the liquid crystal display panel 9. As a result, even if an external environment of the wall 800 changes (e.g., a dew-point temperature of air inside the space 30 decreases), it is possible to prevent occurrence of dew condensation effectively.

Note that, in the wall 800 according to the present embodiment shown in FIG. 19 to FIG. 21, one display device 802 is provided to one of opposite faces of the wall body 801. However, the wall 800 of the present embodiment can be modified such that multiple display devices 802 are provided to the wall body 801. Further, in this case, multiple display device 802 are not limited to being provided to one of opposite faces of the wall body 801, but may be situated so as to provide display surfaces on the opposite faces of the wall body 801.

Note that, with regard to the configurations of Embodiments 5 to 8 of the display device according to the present disclosure, the inside of the hollow space is filled with the desiccant, and air inside the space between the glass cover and the liquid crystal panel is allowed to be in contact with the desiccant through holes formed in the side face of the spacer. With regard to these configurations, in each Embodiment, air inside the space between the glass cover and the liquid crystal panel is substituted by dry air, and the air inside the space can be kept in the fine dry state owing to the desiccant. If dry effects due to the desiccant can make normal air inside the space be in the dry state, there is no need to substitute normal air inside the space by dry air in some cases. Similarly, if desiccant can be situated in a place other than the inside of the hollow spacer so as to allow normal air inside the space to be in contact with the desiccant, it is possible to make air inside the space between the glass cover and the liquid crystal panel be in the dry state without substituting normal air inside the space between the glass cover and the liquid crystal panel by dry state because the desiccant can absorb moisture contained in normal air to make dry air.

As described above, Embodiments 1 to 8 are described as examples of the display device disclosed by the present application. However, the techniques in the present disclosure are not limited thereto, and can be applied to embodiment subjected to modification, substitution, addition, and/or omission. Additionally, a new embodiment can be derived from a combination of components described with regard to the aforementioned Embodiments 1 to 8.

Hereinafter, additional embodiments are described collectively.

In the explanations to Embodiments 1 to 8, the display panel is a liquid crystal panel. However, the display panel is not limited to the liquid crystal panel. For example, the display panel may be other than a liquid crystal panel, and may be a plasma display panel (PDP), an organic or inorganic EL (ElectroLuminescence) panel, or the like.

Note that, in a case where the display panel situated in the display is not a transmissive liquid crystal panel, there is no need to situate a backlight unit for displaying image in back of the display panel. In this case, it is sufficient that only the drive circuit for driving the display panel to display images is situated in back of the display panel. Thus, the display module is assembled by incorporating only the display panel and the drive circuit into the metal chassis.

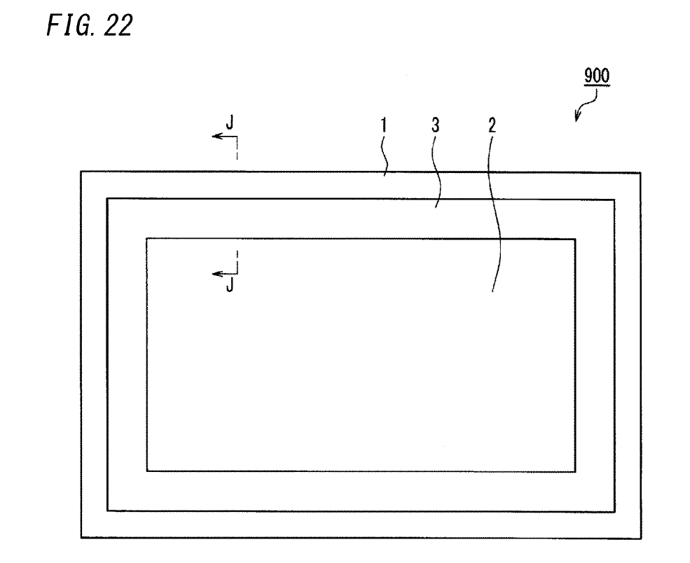

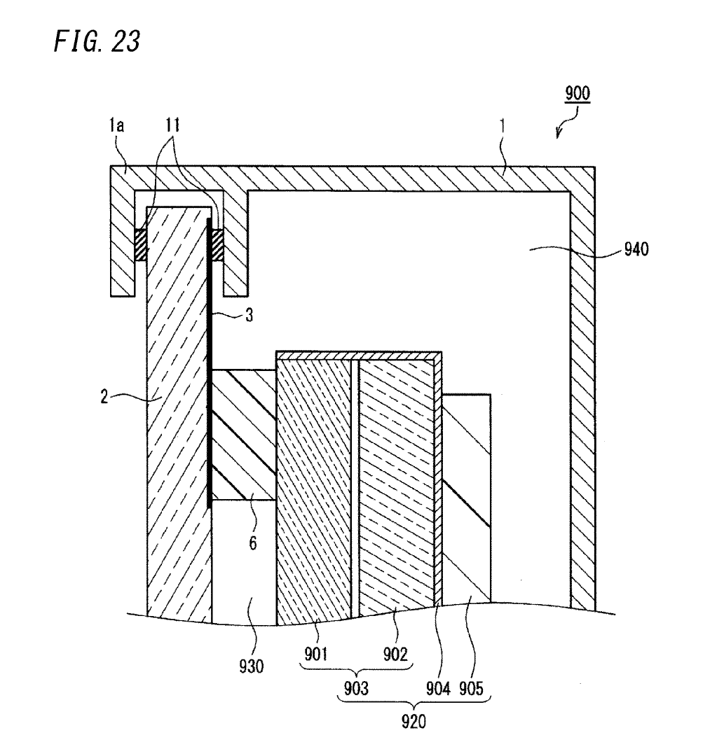

FIG. 22 and FIG. 23 show an example of a configuration of a display device including an EL panel as a display panel.

FIG. 22 is a plan illustrating a whole structure of a display apparatus 900 including an EL panel as the display panel. FIG. 23 is a section illustrating the structure of the display apparatus 900 including the EL panel, and in particular is a section along line J-J in FIG. 22. Note that, the display apparatus 900 including the EL panel described with reference to FIG. 22 and FIG. 23 is same as the display apparatus 100 according to Embodiment 1 described with reference to FIG. 1 to FIG. 3 in the configuration of the glass cover of the display apparatus and the configuration of the cabinet serving as the outer casing of the display apparatus. Therefore, to abbreviate or omit redundant explanations appropriately, components common to the display apparatus according to the present embodiment and the display apparatus 100 of Embodiment 1 are designated by the same reference signs.

As shown in FIG. 22 and FIG. 23, in the display apparatus 900 including the EL panel, a glass cover 2 and a display 920 serving as a display module are arranged in this order from the front side of the display apparatus 900, and are accommodated in a cabinet 1.

The display 920 is different from the displays of Embodiments 1 to 8, and includes an EL panel 903, a circuit board 905, and a metal chassis 904. The EL panel 903 is a display panel including a pair of glass substrates which are a front glass substrate 901 and a rear glass substrate 902. The circuit board 905 is situated in back of the EL panel 903 and is a drive circuit for driving the EL panel 903. The chassis 904 holds the EL panel 903 and the circuit board 905 as a single part.

In contrast to a case of using, as the display panel, a liquid crystal panel which requires a backlight device for displaying images, the configuration of the display module can be simplified in a case where the display panel is selected from a self-emitting panel such as an EL panel and a PDP panel, a display panel based on a field emission emitter, and a reflective liquid crystal panel.

In view of this, as shown in FIG. 23, in many case, the metal chassis 904 constituting the display 920 serving as the display module may be configured to cover not the front face but only the rear face and the side face of the EL panel 903 serving as the display panel, or be configured to cover only the rear face of the EL panel 903. In the configuration where the metal chassis does not cover a periphery of the front face of the display panel, a spacer 6 is provided between the glass cover 2 and a surface of the front glass substrate 901 of the EL panel 903 in order to hermetically enclose a space between the glass cover 2 and the EL panel 903 serving as the display panel. Note that, the weight of the display 920 is reduced because the backlight device is not used. As shown in FIG. 23, the spacer 6 of the display apparatus 100 according to Embodiment 1 is used. The spacer 6 has the simplest configuration, and is in the form of a frame made of a transparent acrylic adhesive tape of 2 mm in thickness. Obviously, the spacer 6 made of transparent acrylic adhesive tape can be replaced by one of various types of spacers of Embodiments 2 to 6.

As for the glass cover 2, a black frame 3 serving as an escutcheon frame is printed on a periphery of an inner face of the glass cover 2. The glass cover 2 is situated in front of the EL panel 903 to protect a display surface of the EL panel 903. As shown in FIG. 23, in the display apparatus 900 including the EL panel 903, an airtight space 930 is formed as a space surrounded by the glass cover 2, the EL panel 903, and the spacer 6. For example, air inside this space 930 is substituted by dry air with a dew point temperature not higher than −20° C., and thus the space 930 is made to be in the dry state.

Also in the display apparatus 900 including the EL panel, as shown in FIG. 23, in a process of accommodating the glass cover 2 in a glass cover holder 1a of the cabinet 1, the glass cover 2 is fixed to the cabinet 1 with seals 11 in-between. Due to this configuration, a space 940 surrounded by a side face and a rear face of the display 920 and the cabinet 1 is made airtight, and thus outside moisture is prevented from intruding into this space 940. Therefore, the space 930 between the glass cover 2 and the EL panel 903 is doubly isolated from an external environment, and thus it is possible to keep the space 930 be in the dry state reliably.

As described above, in a case of using the self-emission display device such as an EL panel as the display panel, the configuration of the display can be simplified. The spacer having a frame shape is interposed between the glass cover and the display panel, and therefore it is possible to make the space between the glass cover and the display panel be in the dry state as with the display devices of aforementioned Embodiments. Even if an external environment of the display apparatus changes (e.g., a dew-point temperature of air inside the space decreases), it is possible to prevent occurrence of dew condensation or reduce probability of occurrence of dew condensation.

Note that, irrespective of whether the backlight unit is used, for example, in a case where the weight of the display module can be reduced, in a process of connecting the glass cover and the display module by the spacer so that the glass cover and the display module are spaced at a predetermined interval, the spacer can be fixed to the surface of the display panel in a similar manner to the configuration shown in FIG. 23. Especially, for example, in a case where the chassis constituting the display module covers only a narrow area around a periphery of the image display surface of the display panel, the front end face of the chassis used for bonding the spacer is narrowed, and therefore it is preferable that the glass cover is bonded to the surface of the display panel by the spacer without using the chassis.

In Embodiments 1 to 8 of the display device according to the present disclosure, the glass cover is a glass cover having an inner face whose periphery is black by printing. However, the glass cover is not limited to having this configuration. For example, a black frame serving as an escutcheon frame is made of a sheet member, and is attached to an inner surface or an outer surface of the glass cover.

Further, the glass cover may include one or more functional films other than the escutcheon frame. For example, if a reflection prevention function is required, a reflection prevention coating may be formed on the front face or both faces of the glass cover, or a reflection prevention film may be attached to the front face or both faces of the glass cover.

Further, in view of an outdoor place receiving sunlight, an infrared reflection function can be added by forming a stack of thin films of silver and oxide on the rear face of the glass cover by sputtering. In a case where the contrast of the image becomes poor due to sunlight outdoors, a louver film may be attached to the front or rear face of the glass cover, and thereby the contrast can be improved.

Further, the glass cover may be a multiple glass panel other than a single glass member shown in each Embodiment. The multiple glass panel includes two or more glass sheets stacked with predetermined spacers in-between. In particular, the multiple glass panel may be a multiple glass panel having thermally insulating properties resulting from a lower pressure inside space. By using the multiple glass panel as the glass cover, it is possible to obtain a thermally insulating effect between the outside and the inside of the glass cover. Therefore, even if an external environment of the display apparatus changes, it is possible to avoid occurrence of dew condensation in the space between the glass cover and the display panel effectively.

As an application example of the configuration in which the glass cover of the display device according to the present disclosure is a multiple glass panel, a configuration in which the display module is situated inside the multiple glass panel and thereby the display device serves as the multiple glass panel as a whole may be considered.

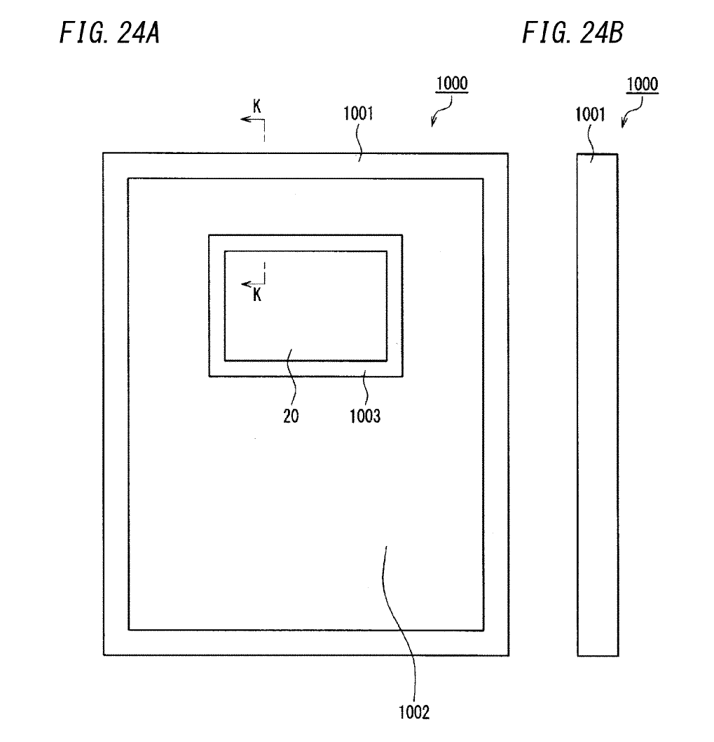

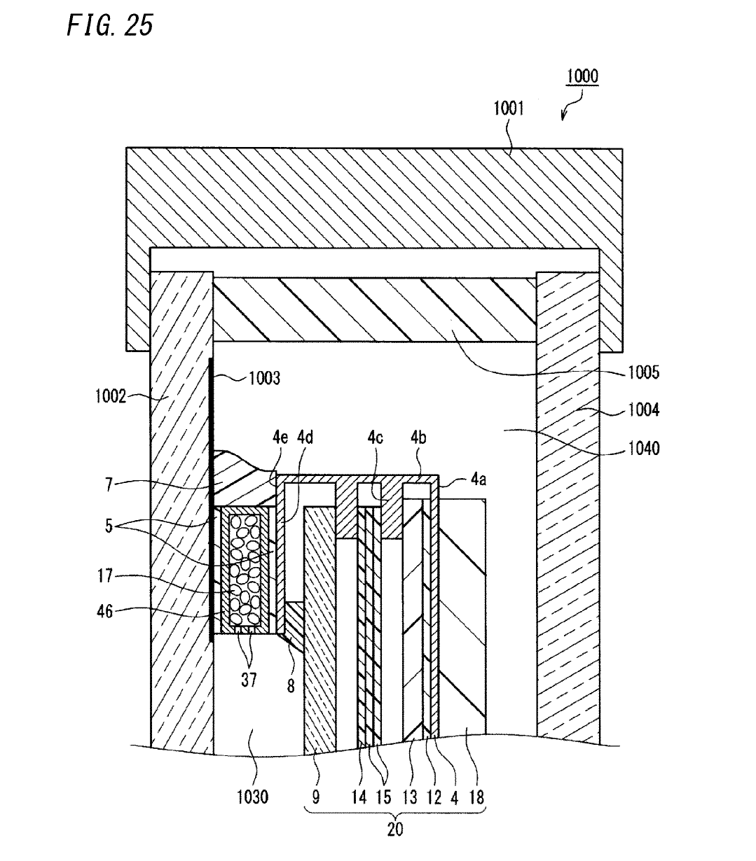

FIG. 24 and FIG. 25 show an example of a configuration of a multiple glass panel including a display apparatus therein.

FIG. 24 shows an appearance of a multiple glass panel 1000 including a display device inside. FIG. 24A is a plan illustrating the multiple glass panel 1000, and FIG. 24B is a side illustrating the multiple glass panel 1000. Further, FIG. 25 is a section illustrating a configuration of the multiple glass panel 1000 including the display device inside, and in particular is an enlarged section along line K-K in FIG. 23A.

Note that, in the multiple glass panel 1000 described with reference to FIG. 24 and FIG. 25, a display 20 serving as the display module fixed to and spaced at a predetermined interval by the spacer from the rear face of the front glass plate of the multiple glass panel used as the glass cover is same as the display 20 used in the display devices of Embodiments 6 to 8, and the inside of the spacer is filled with the desiccant in a similar manner to Embodiments 6 to 8. Obviously, the display device used in the display device incorporated multiple glass panel may include one of various types of spacers used in the display devices of remaining Embodiments 1 to 5. Hereinafter, to avoid redundant repetition, the description of the configuration of the display 20 is omitted.

As shown in FIG. 24 and FIG. 25, as for the multiple glass panel 1000 in which the display device is situated in an inside space of the multiple glass panel 1000, the multiple glass panel is an assembly of a pair of glass plates which are a front glass plate 1002 serving as the glass cover and a rear glass plate 1004 spaced at a predetermined interval from the front glass plate 1002. To adjust an interval between the pair of glass plates 1002 and 1004 to a predetermined value, an interval keeping member 1005 made of metal, resin, or the like is interposed between peripheries of the front glass plate 1002 and the rear glass plate 1004. For example, a sash member 1001 made of aluminum is situated to enclose the front glass plate 1002, the rear glass plate 1004, and the interval keeping member 1005.

Note that, rollers (not shown) are provided to a bottom of the sash member 1001 to allow the multiple glass panel 1000 to slide on a rail formed on a window frame. Thus, it is possible to use the multiple glass panel 1000 as an alternative to a window or a glass door easily.

Note that, a black frame 1003 functioning as an escutcheon is formed by printing, on a periphery of an inner surface of the front glass plate 1002 overlapping a periphery of the display 20 serving as the display module, for example. Therefore, the periphery of the display 20 situated inside the multiple glass panel 1000 and the spacer 46 for bonding the front glass plate 1002 and the display 20 are concealed from viewers in order to improve the appearance.

As shown in FIG. 23, by using the configuration of the display devices of Embodiments 6 to 8, also in the multiple glass panel 1000, a space 1030 between the front glass plate 1002, which doubles as the glass cover, and a liquid crystal panel 9 can be made to be hermetically enclosed, and the space 1030 can be made to be in the dry state by replacing normal air inside the space 1030 by dry air with a dew-point temperature equal to or lower than −20° C., for example.

Further, the space between the pair of glass plates 1002 and 1004 of the multiple glass panel 1000 is isolated from the outside normally. Therefore, as shown in FIG. 25, a space 1040 which is outside the side face and the rear face of the display 20 between the front glass plate 1002 and the rear glass plate 1004 and is covered with the sash member 1001 is hermetically enclosed, and hence outside moisture is prevented from intruding into the space 1040. Consequently, the space 1030 between the front glass plate 1002 and the liquid crystal panel 9 is doubly isolated from an external environment, and thus it is possible to keep the space 1030 be in the dry state reliably.

As described above, by configuring the display device according to the present disclosure so that the display device is situated inside the multiple glass panel, it is possible to realize a glass window or a glass door with a display function which can be easily used as an alternative to a normal sash window and a normal glass door. Consequently, even if an external environment changes, it is possible to prevent or reduce occurrence of dew condensation on the image display surface of the display device.

In each Embodiment described above, the glass cover and the display panel are bonded with the spacer or adhesive layers for bonding the spacer, and the sealing member is situated to enclose the outer limit of the spacer optionally. By doing so, the space between the glass cover and the display panel is made to be airtight. As for the airtightness regarding the space used in the display devices of the present disclosure, it is sufficient that the space between the glass cover and the display panel can be kept in the dry state. In view of this, the pressure of the space in the dry state may be allowed to be equal to or near the atmospheric pressure. By using layers with a certain level of strength as the adhesive layers for bonding the spacer, it is possible to ensure the necessary airtightness of the space. However, when the display panel to be used in the display device is larger and the clearance between the glass cover and the display panel is narrower, it is presumed that expansion or contraction by heat in the space may cause an increase in stress applied on the spacer. In this case, to reduce a difference between pressures inside and outside the space, it is possible to situate a volume control member which is connected to the space between the glass cover and the display panel and controls the volume of the space. The volume control member for the space may be a balloon member having an opening connected to the space. Alternatively, by making part of the spacer of deformable material such as rubber, the spacer can double as the volume control member for the space.

As apparent from the above, the techniques according to the present disclosure are described with reference to Embodiments, and attached drawings and details are provided for the description. The attached drawings and details show components necessary for solving the problem and further may show components which are unnecessary for solving the problem but are used for only describing the above techniques. Therefore, the unnecessary components should not be interpreted as being necessary, on the basis of the fact that the attached drawings and details show the unnecessary components.

Further, the aforementioned Embodiments are used only for describing the techniques according to the present disclosure. Therefore, Embodiments can be subjected to various modification, replacement, addition, and/or omission unless they do not go beyond the scope of claims and their equivalents.

### INDUSTRIAL APPLICABILITY

The techniques according to the present disclosure are applicable to the display devices to be used under severe indoor and outdoor environments. For example, the techniques according to the present disclosure are applicable to display devices to be used indoor or outdoor for information use or digital signage use, and display devices to be used under wet environments such a bathroom.

1. A display device, comprising:
a display panel;
a glass cover situated opposite a front face of the display panel; and
a spacer in a frame shape for fixing the display panel and the glass cover so that the display panel and the glass cover are spaced at a predetermined interval,
a space enclosed by the display panel, the glass cover, and the spacer being kept in a dry state.

2. The display device according to claim 1, wherein
a substance inside the space is replaced with dry air.

3. The display device according to claim 1, further comprising a display module which is an integrated component including the display panel, a drive circuit configured to drive at least the display panel, and a chassis configured to hold the display panel and the drive circuit,
the chassis including a front end situated to cover part of the front face of the display panel, and
the spacer being situated between a surface of the front end of the chassis and the glass cover.

4. The display device according to claim 3, wherein:
the display panel is a transmissive liquid crystal panel; and
the display module further includes a backlight unit for displaying an image on the liquid crystal panel.

5. The display device according to claim 3, further comprising a display panel sealing member situated between the front end of the chassis and the display panel,
the display panel sealing member defining an outer limit of the space.

6. The display device according to claim 1, wherein
an outside of the spacer is hermetically surrounded by a spacer sealing member.

7. The display device according to claim 1, wherein
the spacer is made of a pipy member.

8. The display device according to claim 7, wherein:
at least one hole is formed through a face of the spacer facing the space so as to spatially connect an inside of the spacer and the space together; and
a desiccant is situated in the inside of the spacer.
